(19) United States
(12) Patent Application Publication
(10) Pub. No.: US 2026/0350551 A1
(43) Pub. Date: Nov. 5, 2026

(54) ARTIFICAL INTELLIGENCE (AI) BASED VEHICLE INSPECTION AND SERVICING SYSTEM AND METHOD

(71) Applicant: State Farm Mutual Automobile Insurance Company, Bloomington, IL (US)

(72) Inventors: Aaron Williams, Congerville, IL (US); John Hurliman, Bloomington, IL (US)

(21) Appl. No.: 19/660,999

(22) Filed: Apr. 28, 2026

Related U.S. Application Data
(60) Provisional application No. 63/798,320, filed on May 1, 2025.

(51) Int. Cl. G06Q 10/20; G07C 5/08; G06N 20/00

(52) U.S. Cl. CPC G06Q 10/20; G07C 5/0808; G07C 5/0816; G06N 20/00

(57) ABSTRACT

A computer system may be configured to: (a) receive vehicle data from a vehicle controller of a vehicle, the vehicle data collected by one or more vehicle sensors in communication with the vehicle controller, the vehicle data relating to at least one of a plurality of vehicle subsystems; (b) execute a first AI model by inputting the vehicle data into the first AI model to output an inspection report identifying at least one service issue within at least one vehicle subsystem; (c) execute a second AI model by inputting the inspection report into the second AI model to output a repair data packet including a repair plan for addressing the at least one service issue within the at least one vehicle subsystem; and (d) transmit the repair data packet to at least one of a user computing device associated with the user of the vehicle or the vehicle controller.

### CROSS-REFERENCE TO RELATED APPLICATIONS

This application claims the benefit of priority to U.S. Provisional Patent Application No. 63/798,320, filed May 1, 2025, and entitled “ARTIFICAL INTELLIGENCE (AI) BASED VEHICLE INSPECTION AND SERVICING SYSTEM AND METHOD,” the entire contents and disclosures of which are hereby incorporated by reference herein in their entirety.

### FIELD OF DISCLOSURE

The present disclosure generally relates to artificial intelligence (AI) models used to inspect and service a vehicle, and, more particularly, to an AI-based vehicle inspection and servicing system and method for analyzing vehicle data, identifying service issues with a vehicle, generating a repair plan, and providing the repair plan to address the service issues.

### BACKGROUND

Motor vehicles are used throughout today’s world. These vehicles may include automobiles, trucks, recreational vehicles, motorcycles, buses, boats, etc. These vehicles may be human-driven, autonomous, or semi-autonomous. In all cases, such vehicles require maintenance and repair. Computing devices may be used to retrieve and display information about such maintenance and repair. However, because each vehicle and each repair is unique, the types of general information that may be retrieved using computers (e.g., through Internet searches) may not apply to specific vehicles. For example, how a vehicle has been driven, where it has been driven, how it has been maintained, and what type of vehicle it is all factor into repairing and maintaining a vehicle. In addition, how sophisticated a user or owner of a vehicle is may determine whether the user wants to perform a repair service on their own or hire a third-party provider. It is difficult to account for all of these factors when recommending a maintenance or repair service.

Conventional techniques may include additional inadequacies, ineffectiveness, encumbrances, inefficiencies, and other drawbacks as well.

The present embodiments may relate to, inter alia, systems and methods for inspecting and servicing a vehicle using AI-based tools. The system may collect data relating to a selected vehicle from a vehicle controller of the selected vehicle as well as other data sources. Using the collected data, the system may execute a first AI model by inputting the vehicle data into the first AI model to output an inspection report identifying at least one service issue within a subsystem of the vehicle. The system may further execute a second AI model by inputting the inspection report into the second AI model to output a repair data packet including a repair plan for addressing the at least one service issue within the at least one vehicle subsystem. As described in further detail below, the repair data packet may be transmitted to various types of user computing devices, such as mobile devices, wearables, smart watches, smart contact lenses, smart glasses, augmented reality glasses, virtual reality headsets, mixed or extended reality glasses or headsets, voice bots, chatbots, machine learning (ML) models, ChatGPT or ChatGPT-based bots, which upon receiving the repair data packet may present the repair plan including a description of the at least one service issue and a recommendation on how to service the at least one service issue. This repair plan may be interactive and/or continually updated based upon feedback from the user and/or newly received data.

In one aspect, a computer system for inspecting and servicing a vehicle associated with a user using AI-based tools is provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer system may include at least one processor and/or associated transceiver in communication with at least one memory device. The at least one processor may be in further communication with a vehicle controller. The at least one processor may be programmed to: (i) receive vehicle data from the vehicle controller of a selected vehicle, the vehicle data collected by one or more vehicle sensors in communication with the vehicle controller, the vehicle data relating to at least one of a plurality of vehicle subsystems; (ii) execute a first AI model by inputting the vehicle data into the first AI model to output an inspection report identifying at least one service issue within at least one vehicle subsystem; (iii) execute a second AI model by inputting the inspection report into the second AI model to output a repair data packet including a repair plan for addressing the at least one service issue within the at least one vehicle subsystem; and/or (iv) transmit the repair data packet to at least one of a user computing device associated with the user of the vehicle or the vehicle controller, wherein the repair data packet includes computer instructions that cause the user computing device or the vehicle controller to display the repair plan including a description of the at least one service issue and a recommendation on how to service the at least one service issue. The computer system may include additional, less, or alternate functions, including those discussed elsewhere herein.

In another aspect, a computer-implemented method for inspecting and servicing a vehicle associated with a user using AI-based tools is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device. The at least one processor may be in further communication with a vehicle controller. The method may include: (i) receiving vehicle data from the vehicle controller of a selected vehicle, the vehicle data collected by one or more vehicle sensors in communication with the vehicle controller, the vehicle data relating to at least one of a plurality of vehicle subsystems; (ii) executing a first AI model by inputting the vehicle data into the first AI model to output an inspection report identifying at least one service issue within at least one vehicle subsystem; (iii) executing a second AI model by inputting the inspection report into the second AI model to output a repair data packet including a repair plan for addressing the at least one service issue within the at least one vehicle subsystem; and/or (iv) transmitting the repair data packet to at least one of a user computing device associated with the user of the vehicle or the vehicle controller, wherein the repair data packet includes computer instructions that cause the user computing device or the vehicle controller to display the repair plan including a description of the at least one service issue and a recommendation on how to service the at least one service issue. The computer-implemented method may include additional, less, or alternate actions, including those discussed elsewhere herein.

In another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device. The computer-executable instructions may direct or cause the at least one processor to: (i) receive vehicle data from the vehicle controller of a selected vehicle, the vehicle data collected by one or more vehicle sensors in communication with the vehicle controller, the vehicle data relating to at least one of a plurality of vehicle subsystems; (ii) execute a first AI model by inputting the vehicle data into the first AI model to output an inspection report identifying at least one service issue within at least one vehicle subsystem; (iii) execute a second AI model by inputting the inspection report into the second AI model to output a repair data packet including a repair plan for addressing the at least one service issue within the at least one vehicle subsystem; and (iv) transmit the repair data packet to at least one of a user computing device associated with the user of the vehicle or the vehicle controller, wherein the repair data packet includes computer instructions that cause the user computing device or the vehicle controller to display the repair plan including a description of the at least one service issue and a recommendation on how to service the at least one service issue. The non-transitory computer-readable media having computer-executable instructions embodied thereon may have additional, less, or alternate functionality, including that discussed elsewhere herein.

In another aspect, a computer system for inspecting and servicing a vehicle associated with a user using AI-based tools is provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer system may include at least one processor and/or associated transceiver in communication with at least one memory device. The at least one processor is programmed to (i) receive audio data from at least one audio sensor configured to detect sound produced by a selected vehicle; (ii) execute an AI model by inputting the audio data into the AI model to cause the AI model to output a repair data packet defining at least one service issue within at least one vehicle subsystem of the vehicle, the AI model trained based upon historical sets of audio data and historically identified service issues associated with one or more of the historical sets of audio data; and/or (iii) transmit the repair data packet to a user computing device, wherein the repair data packet causes the user computing device to present the at least one service issue to the user. The computer system may include additional, less, or alternate functions, including those discussed elsewhere herein.

In another aspect, a computer-implemented method for inspecting and servicing a vehicle associated with a user using AI-based tools is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device. The method may include: (i) receiving, by the at least one processor audio data from at least one audio sensor configured to detect sound produced by a selected vehicle; (ii) executing, by the at least one processor, an AI model by inputting the audio data into the AI model to cause the AI model to output a repair data packet defining at least one service issue within at least one vehicle subsystem of the vehicle, the AI model trained based upon historical sets of audio data and historically identified service issues associated with one or more of the historical sets of audio data; and/or (iii) transmitting, by the at least one processor, the repair data packet to a user computing device, wherein the repair data packet causes the user computing device to present the at least one service issue to the user. The computer-implemented method may include additional, less, or alternate actions, including those discussed elsewhere herein.

In another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device. The computer-executable instructions may direct or cause the at least one processor to: (i) receive audio data from at least one audio sensor configured to detect sound produced by a selected vehicle; (ii) execute an AI model by inputting the audio data into the AI model to cause the AI model to output a repair data packet defining at least one service issue within at least one vehicle subsystem of the vehicle, the AI model trained based upon historical sets of audio data and historically identified service issues associated with one or more of the historical sets of audio data; and/or (iii) transmit the repair data packet to a user computing device, wherein the repair data packet causes the user computing device to present the at least one service issue to the user. The non-transitory computer-readable media having computer-executable instructions embodied thereon may have additional, less, or alternate functionality, including that discussed elsewhere herein.

In another aspect, a computer system for inspecting and servicing a vehicle associated with a user using AI-based tools is provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer system may include at least one processor and/or associated transceiver in communication with at least one memory device. The at least one processor may be in further communication with at least one augmented reality (AR) or virtual reality (VR) interface. The at least one processor may be programmed to: (i) receive vehicle data collected by one or more sensors, the vehicle data relating to a selected vehicle; (ii) receive an image or video stream captured at the at least one AR or VR interface; (iii) execute a first AI model by inputting the vehicle data into the first AI model causing the first AI model to output at least one service issue within at least one vehicle subsystem of the selected vehicle; (iv) execute a second AI model by inputting the at least one service issue into the second AI model to output at least one instructional label relating to repairing the at least one service issue within the at least one vehicle subsystem; and/or (v) cause the at least one AR or VR interface to overlay the at least one instructional label onto the image or video stream in real-time in a location relating to the at least one service issue within the at least one vehicle subsystem to present the at least one instructional label to the user. The computer system may include additional, less, or alternate functions, including those discussed elsewhere herein.

In another aspect, a computer-implemented method for inspecting and servicing a vehicle associated with a user using AI-based tools is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device. The at least one processor may be in further communication with at least one AR or VR interface. The method may include: (i) receiving, by the at least one processor, vehicle data collected by one or more sensors, the vehicle data relating to a selected vehicle; (ii) receiving, by the at least one processor, an image or video stream captured at the at least one AR or VR interface; (iii) executing, by the at least one processor, a first AI model by inputting the vehicle data into the first AI model causing the first AI model to output at least one service issue within at least one vehicle subsystem of the selected vehicle; (iv) executing, by the at least one processor, a second AI model by inputting the at least one service issue into the second AI model to output at least one instructional label relating to repairing the at least one service issue within the at least one vehicle subsystem; and/or (v) causing, by the at least one processor, the at least one AR or VR interface to overlay the at least one instructional label onto the image or video stream in real-time in a location relating to the at least one service issue within the at least one vehicle subsystem to present the at least one instructional label to the user. The computer-implemented method may include additional, less, or alternate actions, including those discussed elsewhere herein.

In another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with at least one AR or VR interface. The computer-executable instructions may direct or cause the at least one processor to: (i) receive vehicle data collected by one or more sensors, the vehicle data relating to a selected vehicle; (ii) receive an image or video stream captured at the at least one AR or VR interface; (iii) execute a first AI model by inputting the vehicle data into the first AI model causing the first AI model to output at least one service issue within at least one vehicle subsystem of the selected vehicle; (iv) execute a second AI model by inputting the at least one service issue into the second AI model to output at least one instructional label relating to repairing the at least one service issue within the at least one vehicle subsystem; and/or (v) cause the at least one AR or VR interface to overlay the at least one instructional label onto the image or video stream in real-time in a location relating to the at least one service issue within the at least one vehicle subsystem to present the at least one instructional label to the user. The non-transitory computer-readable media having computer-executable instructions embodied thereon may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the computer systems and computer-based methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a computing system for inspecting and servicing a vehicle using AI-based tools according to an exemplary embodiment of the present disclosure.

FIG. 2 illustrates a computer system for collecting data for inspecting and servicing a vehicle using AI-based tools according to an exemplary embodiment of the present disclosure.

FIG. 3 illustrates a method for collecting data for inspecting and servicing a vehicle using AI-based tools according to an exemplary embodiment of the present disclosure.

FIG. 4 illustrates an exemplary configuration of a user computer device according to an exemplary embodiment of the present disclosure.

FIG. 5 illustrates an exemplary configuration of a server computing device according to an exemplary embodiment of the present disclosure.

FIG. 6 illustrates another exemplary configuration of a server computing device according to an exemplary embodiment of the present disclosure.

FIG. 7 illustrates an exemplary vehicle according to an exemplary embodiment of the present disclosure.

FIG. 8 illustrates an exemplary augmented reality (AR) or virtual reality (VR) interface according to an exemplary embodiment of the present disclosure.

FIG. 9 illustrates another exemplary AR or VR interface according to an exemplary embodiment of the present disclosure.

FIG. 10 illustrates another exemplary AR or VR interface according to an exemplary embodiment of the present disclosure.

FIG. 11A depicts a flowchart of an exemplary computer-implemented method for inspecting and servicing a vehicle using AI-based tools according to an exemplary embodiment of the present disclosure.

FIG. 11B is a continuation of the flowchart shown in FIG. 11A.

FIG. 11C is a continuation of the flowchart shown in FIGS. 11A and 11B.

FIG. 11D is a continuation of the flowchart shown in FIGS. 11A-11C.

FIG. 11E is a continuation of the flowchart shown in FIGS. 11A-11D.

FIG. 12A a flowchart of an exemplary computer-implemented method for inspecting and servicing a vehicle based upon audio and/or image data using AI-based tools according to an exemplary embodiment of the present disclosure.

FIG. 12B is a continuation of the flowchart shown in FIG. 12A.

FIG. 12C is a continuation of the flowchart shown in FIGS. 12A and 12B.

FIG. 13A depicts a flowchart of an exemplary computer-implemented method for providing an AR or VR interface for inspecting and servicing a vehicle using AI-based tools according to an exemplary embodiment of the present disclosure.

FIG. 13B is a continuation of the flowchart shown in FIG. 13A.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for inspecting and servicing a vehicle using AI-based tools. The system may collect data relating to a selected vehicle from a vehicle controller of the selected vehicle as well as other data sources. Using the collected vehicle data, the system may execute a first AI model by inputting the vehicle data into the first AI model to output an inspection report identifying at least one service issue within a subsystem of the vehicle. The system may further execute a second AI model by inputting the inspection report into the second AI model to output a repair data packet including a repair plan for addressing the at least one service issue within the at least one vehicle subsystem.

As described in further detail below, the repair data packet may be transmitted to various types of user computing devices, such as mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, which upon receiving the repair data packet may present the repair plan including a description of the at least one service issue and a recommendation on how to service the at least one service issue. This repair plan may be interactive and/or continually updated based upon feedback from the user and/or newly received data.

In an exemplary embodiment, the system may be in communication with a plurality of vehicles each including a respective vehicle controller and one or more vehicle sensors. The vehicle sensors may include, for example, audio sensors, video sensors, diagnostic sensors mounted within the vehicle, and/or other types of sensor for detecting or measuring parameters associated with the vehicle. The system may be configured to receive vehicle data from the vehicle controller of a selected vehicle. This vehicle data may be collected by the one or more vehicle sensors in communication with the vehicle controller, and may relate to at least one of a plurality of vehicle subsystems of the vehicle. For example, the vehicle data may include audio data, video data, vehicle diagnostic data and/or other types of sensor data that are associated with the vehicle for describing a parameter that may be used for inspecting the vehicle.

The system may further include or be in communication with one or more user devices such as, for example, a smart phone, a tablet smart glasses, a virtual reality (VR) headset, an augmented reality (AR) headset, or other smart wearable device. In some embodiments, in addition to receiving vehicle data from the vehicle itself, the system may receive additional vehicle data from these one or more user computing devices. This additional vehicle data may include, for example, audio data, video data, image data, and/or text data inputted via the user computing device.

The system may be configured to communicate with a computer application executed on the user computing device or the vehicle controller, and may receive a request message to inspect the selected vehicle via the computer application. In these cases, the request message may cause the system to retrieve the vehicle data from the vehicle controller or the user computing device as described above.

The system may be further configured to execute a first AI model (or any number of AI models) that is configured to analyze vehicle data and identify service issues within the vehicle including service issues within one or more subsystems included within the vehicle. For example, the system may input vehicle data into the first AI model, which may cause the first AI model to output an inspection report that identifies at least one service issue within a vehicle subsystem of the vehicle (e.g., braking subsystem, safety control subsystem, infotainment subsystem, etc.). The first AI model may include at least one of a large language model (LLM), a small language model (SLM), an ML model, computer vision tools, and/or a Generative AI model.

The system may be further configured to execute a second AI model (or any number of AI models) that is configured to analyze vehicle data and/or the generated inspection report to generate a repair data packet that includes a repair plan for servicing the identified service issues within the subsystems included within the vehicle. For example, the system may input the inspection report generated by the first AI model into the second AI model, which may cause the second AI model to output the repair data packet including the repair plan for addressing the identified service issues. Like the first AI model, the second AI model may include at least one of an LLM, an SLM, an ML model, computer vision tools, and/or a Generative AI model. In some example implementations, the first AI model and the second AI model are different or executed separately from each other. Alternatively, the first AI model and the second AI model may be the same AI model.

In some embodiments, the system may receive vehicle data that includes live or recorded video stream data showing the selected vehicle, image data showing the selected vehicle, audio data associated with operation of the selected vehicle, diagnostic data of the selected vehicle, and/or some combination thereof. In such embodiments, the system may execute the first AI model by inputting the live or recorded video stream data, image data, audio data, diagnostic data and/or other vehicle data to cause the first AI model to output the inspection report identifying the at least one service issue, and may execute the second AI model by inputting the live or recorded video stream data, image data, audio data, diagnostic data and/or other vehicle data and the inspection report into the second AI model to output the repair data packet.

In certain embodiments the system may be further configured to train a plurality of AI models (e.g., the first AI model and the second AI model) using historical data associated with the selected vehicle and/or other vehicles. This historical data may include, for example vehicle manufacturer’s data, vehicle schematic data, common issues and solutions data for the selected vehicle located via the Internet, expert insight data, local repair locations data, ratings data for local repair shops, vehicle parts ordering data, vehicle and device repair manuals, vehicle software data, insurance claims data, and other data relating to the inspection and repair of the selected vehicle and/or vehicles in general.

The system may be configured to transmit the repair data packet to at least one of a user computing device associated with the user of the vehicle or the vehicle controller. The repair data packet may include computer instructions that cause the user computing device or the vehicle controller to display the repair plan including a description of identified service issues and a recommendation on how to service the vehicle based on the identified service issues. In some embodiments, the vehicle plan may be displayed along with a user prompt requesting whether the user plans to perform the repair plan on their own or if they would prefer third-party help.

In response to the user responding to the user prompt with an indication that the user will perform the repair plan themselves, the system may execute the second AI model to output the repair data packet so that the data packet includes computer instructions that, when executed by the user computing device, cause the user computing device to display, for example, (i) the repair plan, (ii) a video showing how to perform the repair plan, and (iii) selectable links for purchasing vehicle parts needed to perform the repair plan. In another example, the computer instructions may cause the user computing device to (i) display the repair plan, (ii) play audio of step-by-step instructions on how to perform the repair plan, and (iii) display selectable links for purchasing vehicle parts needed to perform the repair plan.

In a further example in which the user device includes or is in communication with an AR or VR device (e.g., smart glasses or a headset), the computer instructions may cause the user computing device to create an AR or VR display showing (i) the repair plan, (ii) step-by-step guided instructions on how to perform the repair plan showing the repairs being made on the vehicle, and (iii) selectable links for purchasing vehicle parts needed to perform the repair plan. In these examples, the computer instructions may also cause the user computing device to create an AR or VR display enabling the user to audibly submit questions regarding the repair plan, and the second AI model may be further configured to output responses to the submitted questions.

In response to the user responding to the user prompt with an indication that the user prefers to have a third-party perform the repair plan, the system may further execute the second AI model to output the repair data packet so that the repair data packet includes computer instructions that, when executed by the user computing device, cause the user computing device to display (i) the repair plan, and (ii) a list of third-party providers capable of performing the repair plan on the selected vehicle. The computer instructions may further cause the user computing device to display user selectable links each associated with a third-party provider capable of performing the repair plan on the selected vehicle. In response to one of the user selectable links being selected, the system may (i) cause a schedule to be displayed on the user computing device showing an availability of the corresponding third-party provider for performing the repair plan, and (ii) enable the user to schedule a time for the corresponding third-party provider to perform the repair plan. The system may further enable the user to request repair quotes from each of the third-party providers associated with the user selectable links for performing the repair plan and cause the repair quotes to be displayed on the user computing device after being received from the third-party providers.

Additionally, the system may facilitate payment for purchasing any goods or services from selected third-party providers. For example, the user may select one of the repair quotes at the user computing device, via the AR or VR display, and/or via an interface of a connected autonomous and/or semi-autonomous vehicle, and the system may utilize stored payment information associated with the user and/or request payment information from the user for completing the purchase.

The system may be further configured to store a vehicle profile for the selected vehicle in one or more memory devices such as a database. The stored vehicle profile may include, for the selected vehicle, the vehicle data, the inspection report, the repair plan, any vehicle parts purchased associated with the repair plan, and an indication from the user as to whether the repair plan was performed. The system may continually update the stored vehicle profile with subsequently collected vehicle data, inspection reports, repair plans, vehicle parts purchased, and indications as to whether the repair plans were performed. In some embodiments, the system may provide the updated vehicle profile to an approved third party for review. For example, if the user of the vehicle opts to share the vehicle profile, the system may provide a portal or interface through which a repair technician, potential buyer, vehicle inspector, insurer, or other interested party may review the vehicle profile to determine a condition of the vehicle and/or whether the vehicle has been well-maintained.

At least one technical problem addressed by this system may include: (a) inability of computing devices to identify and present users with contextually relevant maintenance or repair information related to vehicles and vehicle subsystems; (b) inability of user interfaces to present dynamic and/or real time information to individuals about vehicle subsystems and interventions associated therewith using an augmented reality or virtual reality interface; (c) inability of computing devices to receive user inputs in various formats and prepare responses in various formats according to user preference and/or other criteria; and/or (d) inability of computing devices to incorporate user feedback into the generation and presentation of contextually relevant maintenance or repair information relating to vehicles.

A technical effect of the systems and processes described herein may be achieved by performing at least one of the following: (a) receiving vehicle data from a vehicle controller of a selected vehicle, the vehicle data collected by one or more vehicle sensors in communication with the vehicle controller, the vehicle data relating to at least one of a plurality of vehicle subsystems; (b) executing a first AI model by inputting the vehicle data into the first AI model to output an inspection report identifying at least one service issue within at least one vehicle subsystem; (c) executing a second AI model by inputting the inspection report into the second AI model to output a repair data packet including a repair plan for addressing the at least one service issue within the at least one vehicle subsystem; and (d) transmitting the repair data packet to at least one of a user computing device associated with the user of the vehicle or the vehicle controller, wherein the repair data packet includes computer instructions that cause the user computing device or the vehicle controller to display the repair plan including a description of the at least one service issue and a recommendation on how to service the at least one service issue.

At least one technical effect achieved by this system may be one of: (a) computing devices technologically enabled to present a user interface that identifies and presents users with contextually relevant maintenance or repair information related to vehicles and vehicle subsystems in response to user inquiries; (b) computing device technologically enabled to present a live or real-time, dynamically updatable overlay on image/video streams as an augmented reality display that guides users to and through maintenance and/or repair tasks; (c) computing devices technically enabled to receive user inputs, including profile entries and user inquiries, in a variety of formats (including natural language text, image, video, audio, etc.) and to generate and present responses in a parallel or different format (including text, links, video, images, AR overlays, VR representations, etc.); and/or (d) computing devices technically enables to continually improve a machine-learning model with user feedback related to the efficacy of model outputs as well as other criteria such as presentation details.

More generally, a technical effect of the systems and methods described herein may include improvements in leveraging technology such as ML tools and/or other AI-based rules to improve the speed and accuracy of based vehicle inspection and servicing. The system may utilize various forms of input data relating to a vehicle to identify vehicle issues and generate interactive recommendations for responding to these identified issues. Further records of these issues and actions taken to address the issues may be stored in a centralized database for easy storage, management, and retrieval.

### EXEMPLARY COMPUTER SYSTEM

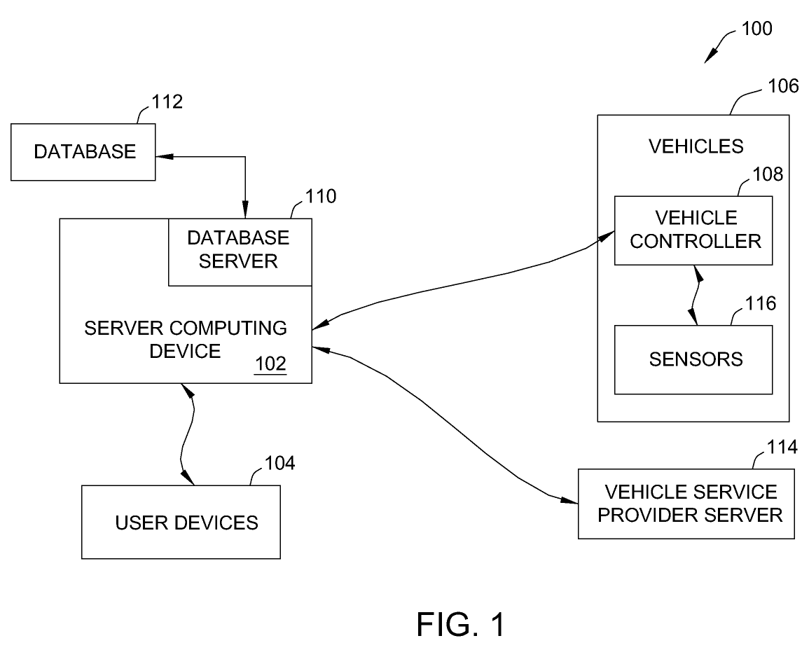

FIG. 1 depicts a simplified block diagram of an exemplary computer system 100. In the exemplary embodiment, system 100 may be used for inspecting and servicing a vehicle using AI-based tools. In the exemplary embodiment, system 100 may include a server computing device 102, one or more user computing devices 104 in communication with server computing device 102, and one or more vehicles 106 each including a vehicle controller 108 in communication with server computing device 102.

The user computer devices 104 may be computers that include a web browser or a software application, which may enable user computer devices 104 to access server computing device 102 using the Internet. More specifically, user computer devices 104 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 104 may be a device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, a drone, chat bots, other web-based connectable equipment or mobile devices, or some combination thereof.

A database server 110 may be communicatively coupled to a database 112 that stores data. Database 112 may include data relating to vehicles 106 and their users, as described in further detail below. In some embodiments, database 112 may be stored remotely from server computing device 102 and/or may be decentralized. In the exemplary embodiment, a person may access database 112 via user computer devices 104 by logging onto server computing device 102, as described herein.

In certain embodiments, server computing device 102 may be associated with or may be part of a computer network associated with an organization (e.g., business, group, school, organization or other user associated network) or in communication with the organizations’ computer network. In other embodiments, server computing device 102 may be associated with a third party and is merely in communication with the organizations’ computer network. One or more vehicle service provider servers 114 may be in communication with server computing device 102. The one or more vehicle service provider servers 114 each may be associated with a vehicle service provider and may enable a scheduling of vehicle services using user computing devices 104 based upon data packets generated by server computing device 102, as described herein.

Vehicles 106 may each include a respective vehicle controller 108 and one or more sensors 116 in communication with vehicle controller 108. Sensors 116 may include, for example, audio sensors, video sensors, diagnostic sensors mounted within the vehicle, and/or other types of sensor for detecting or measuring parameters associated with the vehicle. Server computing device 102 may be configured to receive vehicle data from the vehicle controller 108 of a selected vehicle 106. This vehicle data may be collected by one or more sensors 116 in communication with the vehicle controller 108, and may relate to at least one of a plurality of vehicle subsystems of vehicle 106. For example, the vehicle data may include audio data, video data, vehicle diagnostic data and/or other types of sensor data that are associated with vehicle 106 for describing a parameter that may be used for inspecting vehicle 106.

As described above, server computing device 102 system may further include or be in communication with one or more user computing devices 104 such as, for example, a smart phone, a tablet smart glasses, a VR headset, an AR headset, or other smart wearable device. In some embodiments, in addition to receiving the vehicle data from vehicle 106 itself, server computing device 102 may receive additional vehicle data from these one or more user computing devices 104 (e.g., a user mobile device or other computing device). This additional vehicle data may include, for example, audio data, video data, image data, and/or text data inputted via user computing device 104.

Server computing device 102 may be configured to communicate with a computer application executed on user computing device 104 or vehicle controller 108, and may receive a request message to inspect the selected vehicle 106 via the computer application. In these cases, the request message may cause server computing device 102 to retrieve the vehicle data from vehicle controller 108 or user computing device 104 as described above.

Server computing device 102 may be further configured to execute a first AI model (or any number of AI models) that is configured to analyze vehicle data and identify service issues within vehicle 106 including service issues within one or more subsystems included within vehicle 106. For example, the system may input vehicle data into the first AI model, which may cause the first AI model to output an inspection report that identifies at least one service issue within a vehicle subsystem of vehicle 106. The first AI model may include at least one of an LLM, an SLM, a ML model, computer vision tools, and/or a Generative AI model.

Server computing device 102 may be further configured to execute a second AI model (or any number of AI models) that is configured to analyze vehicle data and/or the generated inspection report to generate a repair packet that includes a repair plan for servicing the identified service issues within the subsystems included within vehicle 106. For example, the system may input the inspection report generated by the first AI model into the second AI model, which may cause the second AI model to output the repair data packet including the repair plan for addressing the identified service issues. Like the first AI model, the second AI model may include at least one of an LLM, an SLM, an ML model, computer vision tools, and/or a Generative AI model. In some example implementations, the first AI model and the second AI model are different or executed separately from each other. Alternatively, the first AI model and the second AI model may be the same AI model.

In some embodiments, server computing device 102 may receive (e.g., from user computing device 104 and/or vehicle controller 108) vehicle data that includes live or recorded video stream data showing the selected vehicle 106, image data showing the selected vehicle 106, audio data associated with operation of the selected vehicle 106, diagnostic data of the selected vehicle 106, and/or some combination thereof. In such embodiments, server computing device 102 may execute the first AI model by inputting the live or recorded video stream data, image data, audio data, diagnostic data and/or other vehicle data to cause the first AI model to output the inspection report identifying the at least one service issue, and may execute the second AI model by inputting the live or recorded video stream data, image data, audio data, diagnostic data and/or other vehicle data and the inspection report into the second AI model to output the repair data packet.

In certain embodiments server computing device 102 may be further configured to train a plurality of AI models (e.g., the first AI model and the second AI model) using historical data associated with the selected vehicle 106 and/or other vehicles 106. This historical data may include, for example vehicle manufacturer’s data, vehicle schematic data, common issues and solutions data for the selected vehicle located via the Internet, expert insight data, local repair locations data, ratings data for local repair shops, vehicle parts ordering data, vehicle and device repair manuals, vehicle software data, insurance claims data, and other data relating to the inspection and repair of the selected vehicle 106 and/or vehicles in general.

Server computing device 102 may be configured to transmit the repair data packet to at least one of a user computing device 104 associated with the user of the vehicle 106 or vehicle controller 108. The repair data packet may include computer instructions that cause user computing device 104 or vehicle controller 108 to display the repair plan including a description of identified service issues and a recommendation on how to service vehicle 106 based on the identified service issues. In some embodiments, the vehicle plan may be displayed along with a user prompt requesting whether the user plans to perform the repair plan on their own or if they would prefer third-party help.

In response to the user responding to the user prompt with an indication that the user will perform the repair plan themselves, server computing device 102 may execute the second AI model to output the repair data packet so that the data packet includes computer instructions that, when executed by the user computing device, cause user computing device 104 to display, for example, (i) the repair plan, (ii) a video showing how to perform the repair plan, and (iii) selectable links for purchasing vehicle parts needed to perform the repair plan. In another example, the computer instructions may cause user computing device 104 to (i) display the repair plan, (ii) play audio of step-by-step instructions on how to perform the repair plan, and (iii) display selectable links for purchasing vehicle parts needed to perform the repair plan.

In a further example in which user computing device 104 includes or is in communication with an AR or VR device (e.g., smart glasses or a headset), the computer instructions may cause user computing device 104 to create an AR or VR display showing (i) the repair plan, (ii) step-by-step guided instructions on how to perform the repair plan showing the repairs being made on the vehicle, and (iii) selectable links for purchasing vehicle parts needed to perform the repair plan. In these examples, the computer instructions that may also cause user computing device 104 to create an AR or VR display enabling the user to audibly submit questions regarding the repair plan, and the second AI model may be further configured to output responses to the submitted questions.

In response to the user responding to the user prompt with an indication that the user prefers to have a third-party perform the repair plan, server computing device 102 may execute the second AI model to output the repair data packet so that the repair data packet includes computer instructions that, when executed by user computing device 104, cause user computing device 104 to display (i) the repair plan, and (ii) a list of third-party providers capable of performing the repair plan on the selected vehicle. The computer instructions may further cause user computing device 104 to display user selectable links each associated with a third-party provider capable of performing the repair plan on the selected vehicle. In response to one of the user selectable links being selected, server computing device 102 may (i) cause a schedule to be displayed on the user computing device showing an availability of the corresponding third-party provider for performing the repair plan, and (ii) enable the user to schedule a time for the corresponding third-party provider to perform the repair plan (e.g., by communicating with a vehicle service provider server 114 associated with the third-party provider). Server computing device 102 may further enable the user to request repair quotes from each of the third-party providers (e.g., via vehicle service provider servers 114) associated with the user selectable links for performing the repair plan and cause the repair quotes to be displayed on the user computing device 104 after being received from the third-party providers.

Additionally, the system may facilitate payment for purchasing any goods or services from selected third-party providers. For example, the user may select one of the repair quotes at the user computing device 104, via the AR or VR display, and/or via an interface of a connected autonomous and/or semi-autonomous vehicle 106, and the system may utilize stored payment information associated with the user and/or request payment information from the user for completing the purchase.

Server computing device 102 may be further configured to store a vehicle profile for the selected vehicle 106 in one or more memory devices such as database 112. The stored vehicle profile may include, for the selected vehicle 106, the vehicle data, the inspection report, the repair plan, any vehicle parts purchased associated with the repair plan, and an indication from the user as to whether the repair plan was performed. Server computing device 102 may continually update the stored vehicle profile with subsequently collected vehicle data, inspection reports, repair plans, vehicle parts purchased, and indications as to whether the repair plans were performed. In some embodiments, server computing device 102 may provide the updated vehicle profile to an approved third party for review. For example, if the user of vehicle 106 opts to share the vehicle profile, server computing device 102 may provide a portal or interface through which a repair technician, potential buyer, vehicle inspector, insurer, or other interested party may review the vehicle profile to determine a condition of vehicle 106 and/or whether vehicle 106 has been well-maintained.

### EXEMPLARY DATA COLLECTION SYSTEM

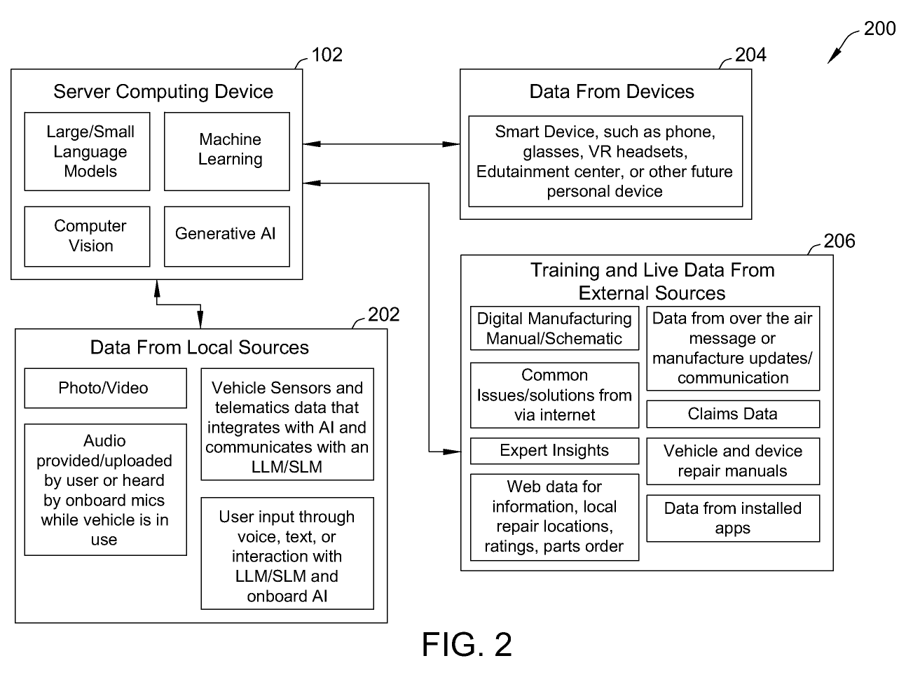

FIG. 2 depicts a diagram 200 illustrating exemplary data that may be collected by server computing device 102 of system 100 (shown in FIG. 1) for inspecting and servicing a vehicle using AI-based tools. For example, the data may be used to identify service issues within subsystems of vehicle 106, generate repair data packets including a repair plan for vehicle 106, and/or generate or train AI models that may be executed to perform these tasks.

Data utilized by server computing device 102 to identify service issues may include data from local sources 202. Data from local sources 202 may include, for example, photo or video data, audio data provided or uploaded by a user or detected by onboard microphones of vehicle 106, telematics data or other data from sensors 116, and/or user input through voice, text, or other interaction with a LLM, SLM, and/or onboard AI of vehicle 106.

Data utilized by server computing device 102 may further include data from devices 204 such as user computing device 104. Data from devices 204 may include data from smart devices such as smart phones, smart glasses, AR or VR headsets, edutainment centers, or other wearable or personal devices. Data from local sources 202 and data from data from devices 204 may be input into one or more AI models as described above, which may correlate data from local sources 202 and data from data from devices 204 with vehicle service issues.

Training and live data from external sources 206 may be used by server computing device 102 to train these one or more AI models. Training and live data from external sources 206 may include, for example, digital manufacturer manuals or schematics, common issues and/or solutions found via the Internet, expert insights, web data for information local repair locations, ratings, or parts orders, data from over-the-air messages, manufacturer updates, or communication, claims data, vehicle or device repair manuals, and/or data from installed apps. This data may be used to train the one or more AI models to identify vehicle service issues based on correlations between subsequent data received from local sources 202 and data from data from devices 204 with the vehicle service issues and to identify actions that typically implemented to address these issues.

### EXEMPLARY METHOD FOR INSPECTING AND SERVICING A VEHICLE

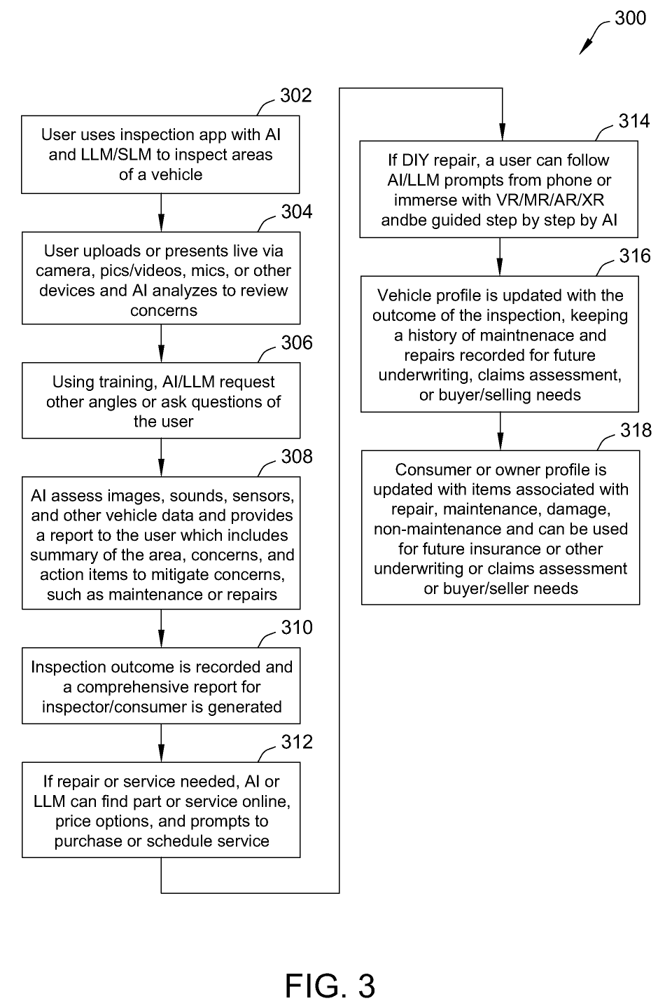

FIG. 3 depicts an exemplary method 300 for inspecting and servicing a vehicle using AI-based tools. Method 300 may include using (block 302) an inspection app executing on user computing device 104 to inspect areas of vehicle 106. For example, the app may provide prompts or instructions for capturing data (e.g., capturing images of parts of vehicle 106 or recording sounds during operation of vehicle 106), and the captured data may be streamed live to server computing device 102. Method 300 may further include analyzing this uploaded data using one or more AI models (block 304). Method 300 may further include prompting the user to collect additional data based on an output of the AI models (block 306). For example, the user may be prompted to provide answers to questions and/or capture images from different angles.

Method 300 may further include, using the captured data (e.g., images, sounds, sensors, and other vehicle data), providing (block 308) a report to the user (e.g., using user computing device 104) that includes summary of the area, concerns, and action items to mitigate concerns, such as maintenance or repairs. Method 300 may further include recording (block 310) an inspection outcome and generating a comprehensive report for review by an inspector or consumer.

Method 300 may further include, if repair or service is determined to be needed, finding (block 312), using the one or more AI models, parts or services and price options online and generating prompts to purchase or schedule services. Method 300 may further include, if the user opts for a do-it-yourself (DIY) repair, providing (block 314) AI-generated prompts and/or immersive step-by-step instructions with VR/MR/AR/XR via user computing device 104.

Method 300 may further include updating (block 316) a vehicle profile with the outcome of the inspection to keep a history of maintenance and repairs recorded for future underwriting, claims assessment, or buyer/seller needs with respect to vehicle 106. Method 300 may further include updating (block 318) a consumer or owner profile with items associated with repair, maintenance, damage, non-maintenance that can be used for future insurance or other underwriting or claims assessment or buyer/seller needs with respect to vehicle 106.

### EXEMPLARY USER DEVICE

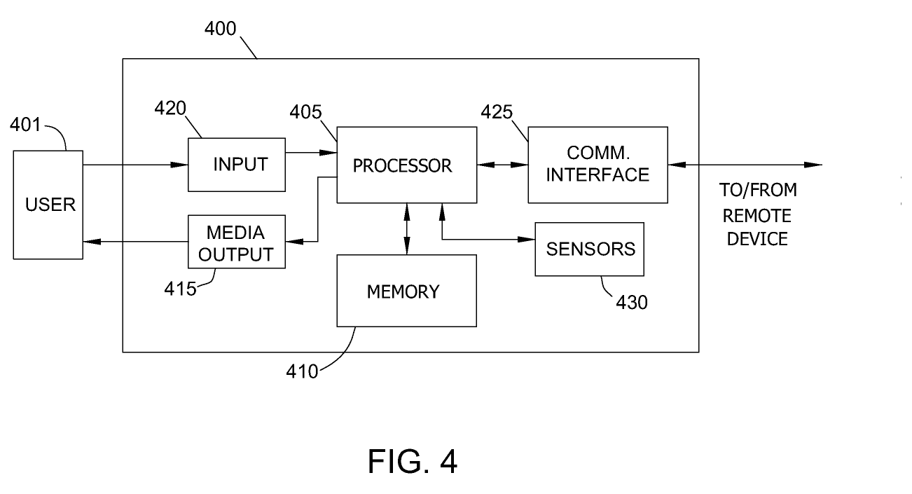

FIG. 4 depicts an exemplary user computing device 400, which may be an exemplary configuration of user computing device 104 shown in FIG. 1, in accordance with one embodiment of the present disclosure. User computing device 400 may be operated by a user 401. User computing device 400 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computing device 400 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively couplable to an output device such as a display device (e.g., a cathode ray tube (CRT), liquid crystal display (LCD), light emitting diode (LED) display, or “electronic ink” display), an audio output device (e.g., a speaker or headphones), or other display devices.

Input device 420 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), and/or a video input device (e.g., a camera). A single component such as a touch screen may function as both an output device of media output component 415 and input device 420.

User computing device 400 may also include a communication interface 425, communicatively coupled to a remote device such as server computing device 102 (shown in FIG. 1). Communication interface 425 may include, for example, a wired or wireless network adapter and/or a wireless data transceiver for use with a mobile telecommunications network.

Stored in memory area 410 may be, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from server computing device 102.

A client application allows user 401 to interact with, for example, the server computing device 102. For example, instructions may be stored by a cloud service, and the output of the execution of the instructions sent to the media output component 415. Processor 505 executes computer-executable instructions for implementing aspects of the disclosure. In some embodiments, the processor 405 is transformed into a special purpose microprocessor by executing computer-executable instructions or by otherwise being programmed.

### EXEMPLARY SERVER DEVICE

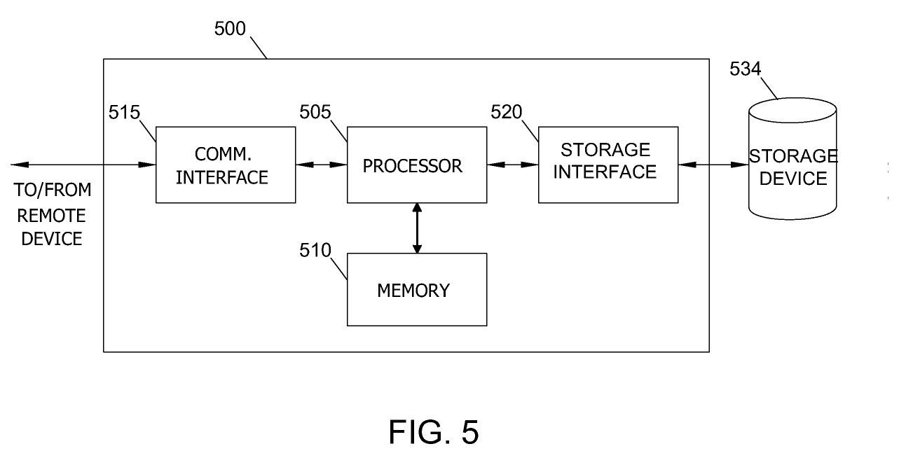

FIG. 5 depicts an exemplary configuration of a server computing device 500, in accordance with one embodiment of the present disclosure. Server computer device 500 may include, but is not limited to, server computing device 102 and/or vehicle service provider servers 114 (all shown in FIG. 1). Server computer device 500 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 500 is capable of communicating with a remote device such as another server computer device 500, user computing devices 104, and/or vehicle controllers 108 (shown in FIG. 1). For example, communication interface 515 may receive requests from user computing devices 104 and/or vehicle controllers 108 via the Internet.

Processor 505 may also be operatively coupled to a storage device 534. Storage device 534 may be any computer-operated hardware suitable for storing and/or retrieving data, such as, but not limited to, data associated with database 112 (shown in FIG. 1). In some embodiments, storage device 534 may be integrated in server computer device 500. For example, server computer device 500 may include one or more hard disk drives as storage device 534.

In other embodiments, storage device 534 may be external to server computer device 500 and may be accessed by a plurality of server computer devices 500. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

Processor 505 may execute computer-executable instructions for implementing aspects of the disclosure. In some embodiments, the processor 505 may be transformed into a special purpose microprocessor by executing computer-executable instructions or by otherwise being programmed.

### EXEMPLARY COMPUTING DEVICE FOR EXECUTING AI TECHNIQUES

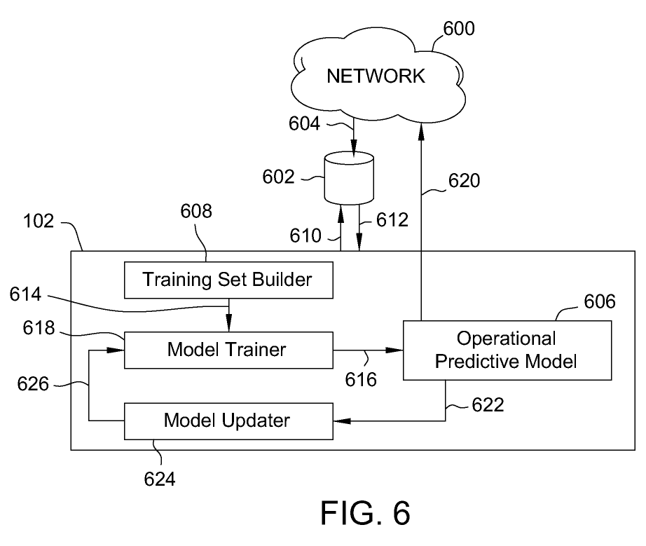

FIG. 6 is a schematic diagram illustrating further detail of server computing device 102 (shown in FIG. 1) according to an exemplary embodiment. Server computing device 102 may communicate with other components of system 100 via a network 600. Server computing device 102 may include and/or be in communication with a database 602 that stores data 604 including historical sensor data and historically identified features. Data 604 received from network 600 may be stored in database 602. Server computing device 102 may configured to use data 604 to generate an operational predictive model module 606 for identifying vehicle service issues and generating instructions and recommendations as described herein.

In exemplary embodiments, server computing device 102 includes a training set builder module 608 configured to submit one or more queries 610 to database 602 to retrieve subsets 612 of data 604, and to use those subsets 612 to build training data sets 614 for generating operational predictive model 616. For example, query 610 may be configured to retrieve certain fields from data 604 having certain similar aspects, such as images having common patterns or features.

In exemplary embodiments, training set builder module 608 may be configured to derive training data sets 614 from retrieved subsets 612. Each training data set 614 corresponds to a historical data 604 (“historical” in this context means completed in the past, as opposed to completed in real-time with respect to the time of retrieval by training set builder module 608). Each training data set 614 may include “model input” data fields along with at least one “result” data field representing historical feedback. The model input data fields represent factors that may be expected to, or unexpectedly be found during model training to, have some correlation with data values and/or features of vehicles 106.

In exemplary embodiments, the model input data fields in training data sets 614 may be generated from data fields in subset 612 corresponding to historical data 604. In other words, a trained ML model 616 produced by a model trainer module 618 for use by operational predictive model module 606 is trained to make predictions based on input values that can be generated from the data fields in data 604. Values in the model input data fields may include values copied directly from values in a corresponding data field in the retrieved subset 612, and/or values generated by modifying, combining, or otherwise operating upon values in one or more data fields in the retrieved subset 612. The use of such data fields as model input data fields facilitates the ML model in weighing these factors directly.

After training set builder module 608 generates training data sets 614, training set builder module 608 passes the training data sets 614 to model trainer module 618. In example embodiments, model trainer module 618 is configured to apply the model input data fields of each training data set 614 as inputs to one or more ML models. Each of the one or more ML models is programmed to produce, for each training data set 614, at least one output intended to correspond to, or “predict,” a value of the at least one result data field of the training data set 614. “Machine learning” refers broadly to various algorithms that may be used to train the model to identify and recognize patterns in existing data in order to facilitate making predictions for subsequent new input data.

Model trainer module 618 is configured to compare, for each training data set 614, the at least one output of the model to the at least one result data field of the training data set 614, and apply a ML algorithm to adjust parameters of the model in order to reduce the difference or “error” between the at least one output and the corresponding at least one result data field. In this way, model trainer module 618 trains the ML model to accurately predict the value of the at least one result data field.

In other words, model trainer module 618 cycles the one or more ML models through the training data sets 614, causing adjustments in the model parameters, until the error between the at least one output and the at least one result data field falls below a suitable threshold, and then uploads at least one trained ML model 616 to operational predictive model module 606 for application to generating predictions 620. In example embodiments, model trainer module 618 may be configured to simultaneously train multiple candidate ML models and to select the best performing candidate for each result data field, as measured by the “error” between the at least one output and the corresponding result data field, to upload to operational predictive model module 606.

In certain embodiments, the one or more ML models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 618 cycles through the training data sets 614, model trainer module 618 applies a suitable backpropagation algorithm to adjust the weights in each node layer to minimize the error between the at least one output and the corresponding result data field. In this fashion, the ML model is trained to produce output that reliably predicts the corresponding result data field. Alternatively, the ML model may have any suitable structure.

In some embodiments, model trainer module 618 provides an advantage by automatically discovering and properly weighting complex, second- or third order, and/or otherwise nonlinear interconnections between the model input data fields and the at least one output. Absent the ML model, such connections are unexpected and/or undiscoverable by human analysts.

In exemplary embodiments, operational predictive model module 606 may compare feedback (e.g., feedback received from homeowners, and/or decisions made by homeowners based upon previous recommendations) and may route a comparison result 622 generated by comparing prediction 620 to the feedback to a model updater module 624 of server computing device 102. Model updater module 624 is configured to derive a correction signal 626 from comparison results 622 received for one or more predictions 620, and to provide correction signal 626 to model trainer module 618 to enable updating or “re-training” of the at least one ML model to improve performance. The retrained at least one ML model 616 may be periodically re-uploaded to operational predictive model module 606.

Furthermore, server computing device 102 may use data from user computing devices 104 and/or vehicle controller 108 as historical data 604, training data sets 614, validation data, and/or other data as needed during the training, retraining, and/or execution of the one or more AI models.

In some embodiments, server computing device 102 trains multiple models, wherein each model is for analyzing a different data type, vehicle type, and/or any other variation or division desired to improve the operation of system 100 described herein.

### EXEMPLARY CONNECTED VEHICLE

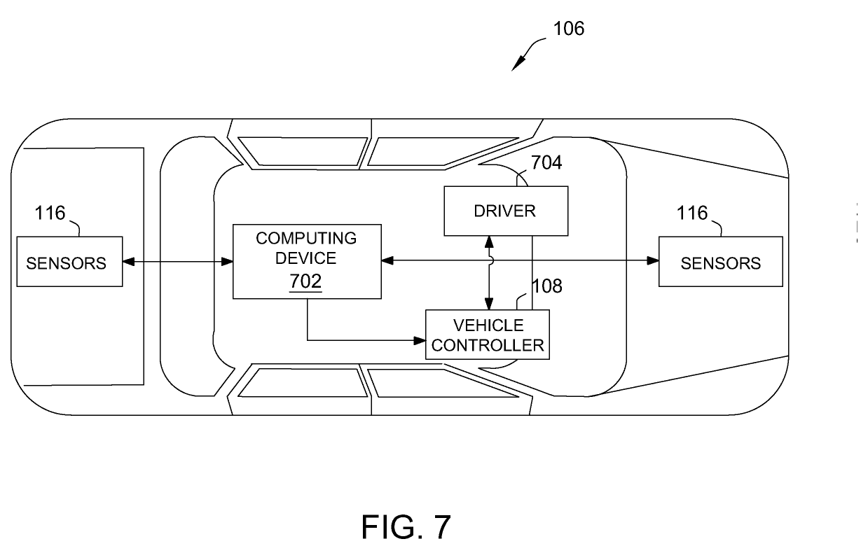

FIG. 7 depicts an exemplary embodiment of vehicle 106. In some embodiments, vehicle 106 may be a conventional and/or at least partially autonomous automobile, a recreational vehicle (RV), a motorcycle, a bicycle, a boat, an airplane, a powered scooter (e.g., an electric scooter), and/or another vehicle.

Vehicle 106 may include a plurality of sensors 116 and a computing device 702. Sensors 116 may include, but are not limited to, temperature sensors, terrain sensors, weather sensors, accelerometers, gyroscopes, radar, LIDAR, Global Positioning System (GPS), video devices, imaging devices, cameras (e.g., 2D and 3D cameras), audio recorders, and computer vision. In some embodiments, sensors 116 may be used to collect, for example, vehicle data, as described above. Such vehicle data collected by sensors 116 may be transmitted to server computing device 102 (shown in FIG. 1).

Computing device 702 may be implemented, for example, as one of user computing devices 104 (shown in FIG. 1). In exemplary embodiments, computing device 702 and/or vehicle controller 108 may receive data from sensors 116. In certain embodiments in which server computing device 102 is remote from vehicle 106, computing device 702 and/or vehicle controller 108 may transmit data received from sensors 116 (e.g., vehicle data) to server computing device 102. Alternatively, server computing device 102 may be implemented as computing device 702.

In exemplary embodiments, vehicle controller 108 may control at least some operation of vehicle 106. For example, vehicle controller 108 may steer, accelerate, or decelerate vehicle 106 based upon data received, for example, from sensors 116. In some embodiments, vehicle controller 108 may include a display screen or touchscreen (not shown) that is capable of displaying information to and/or receiving input from driver 704.

In other embodiments, vehicle controller 108 may be capable of wirelessly communicating with a user mobile device such as user computing device 104. In these embodiments, vehicle controller 108 may be capable of communicating with the user of user computing device 104, such as driver 704, through an application on user computing device 104.

### EXEMPLARY AR OR VR INTERFACE

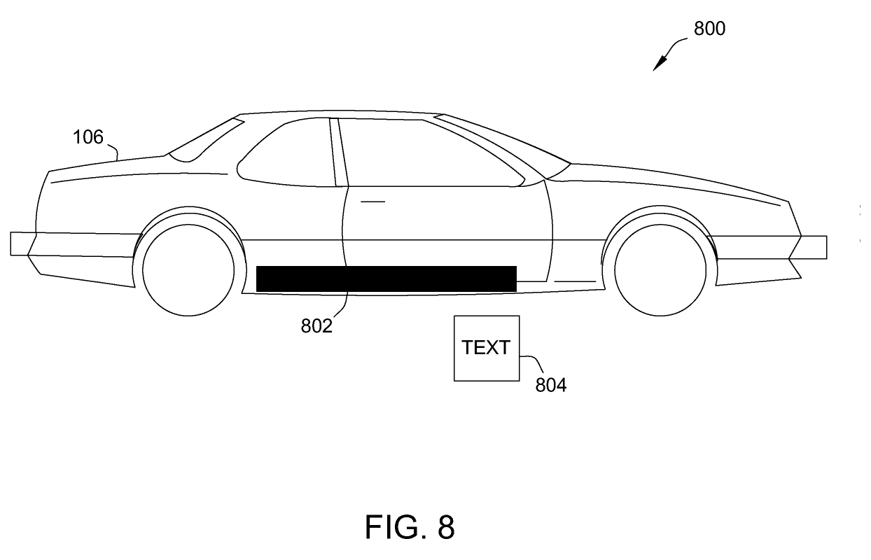

FIG. 8 depict an exemplary AR or VR interface 800. AR or VR interface 800 may be displayed by, for example, a user computing device 104 such as an AR or VR headset. A background of AR or VR interface 800 may include photographic imagery captured by, for example, a camera of user computing device 104. This photographic imagery may be continually updated in real time (e.g., by periodically capturing new images with the camera) so that AR or VR interface 800 represents a present view of, for example, vehicle 106. The background photographic imagery may include a photographic image of vehicle 106. Alternatively, the background imagery including the image of vehicle 106 may be a fixed and/or virtual image. Because a fixed and/or virtual image does need not need to be continually updated, using a fixed and/or virtual image enables a user to view information relating to vehicle 106 without needing to be at a current location of vehicle 106.

In addition to the photographic imagery, AR or VR interface 800 may include an overlay of virtual images generated by, for example, server computing device 102 and/or user computing device 104 based on a repair data packet output by an AI model as described above. The virtual images may include, for example, an object overlay 802 indicating a location of a vehicle subsystem or component of interest within vehicle 106 and/or a text overlay 804 such as labels or instructional text. For example, if a user has opted to perform a DIY repair as described above, for a given step in the repair process, object overlay 802 may indicate a component of vehicle 106 that needs to be removed, replaced, and/or otherwise manipulated and text overlay 804 may include text information about how to perform the step, warnings, or other useful information. In some embodiments, AR or VR interface 800 may also include audio aspects, such as audibly reading contents of text overlay 804 and/or an ability to respond to voice commands (e.g., “zoom in,” “zoom out,” “go to next step,” or general questions that may be responded to using the one or more AI models).

The locations of object overlay 802 and/or text overlay 804 may be continually refreshed (e.g., a location and/or angle of the camera changes with respect to the location of vehicle 106) so that the locations of object overlay 802 and/or text overlay 804 correspond to the actual locations of relevant subsystems and components of vehicle 106. For example, if the viewer of AR or VR interface 800 were to move, object overlay 802 and/or text overlay 804 would also move to maintain their apparent relevant position with respect to vehicle 106.

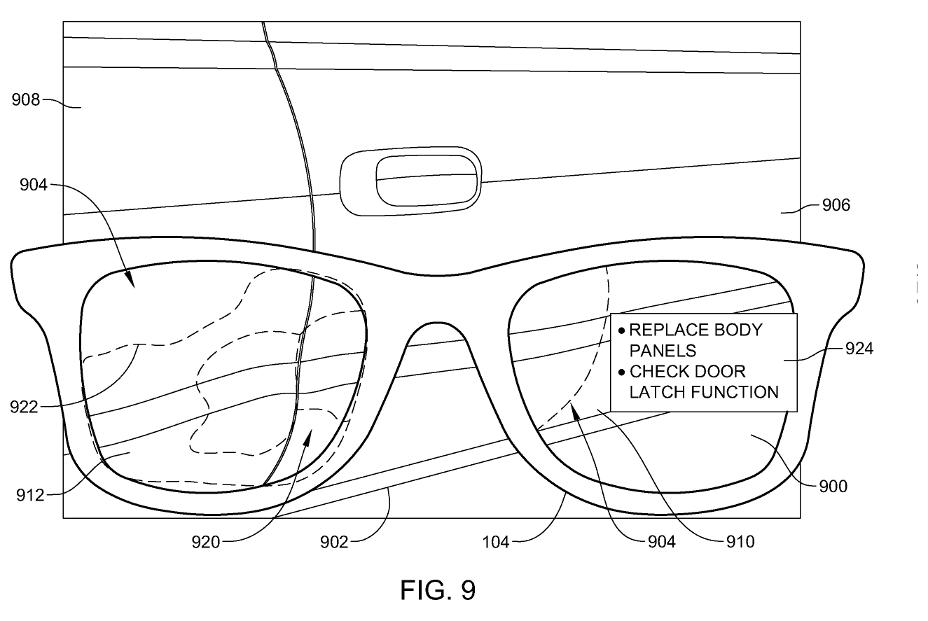

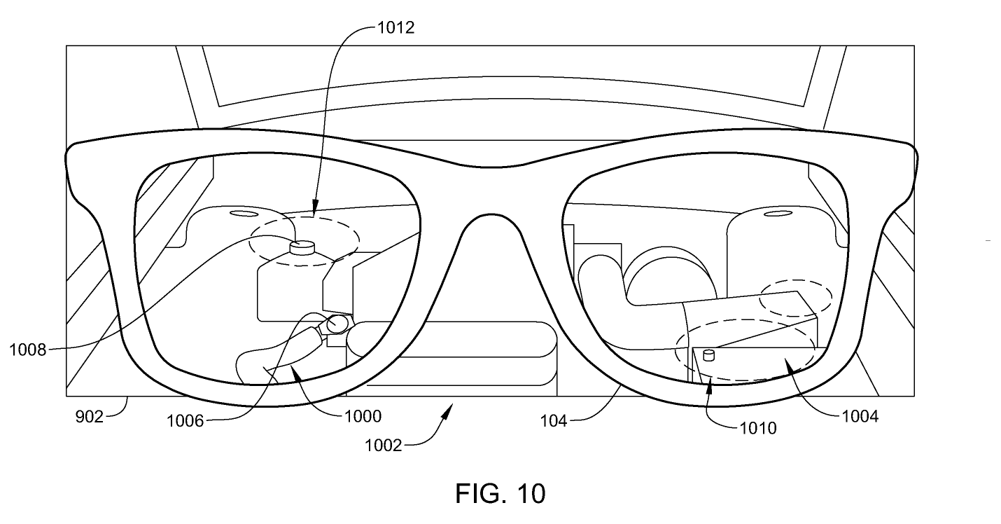

FIGS. 9 and 10 depict exemplary AR interfaces 900 and 1000, respectively, that relate to maintenance and/or repair of vehicles. In such embodiments, the functionality of system 100 may be applied to assist persons in vehicle repair or maintenance, including for the purposes of vehicle inspection or for other purposes such as training or teaching new employees and/or those performing DIY repairs.

Specifically, in FIG. 9, the depicted AR interface 900 may be similar to AR or VR interface 800, in that AR interface 900 may be generated by, for example, computing device 102 and displayed by user device 104, which may be, for example, an AR/VR headset. In this example, AR interface 900 may be an AR representation of a maintenance targeting related to vehicles, such as the detection or identification and/or repair of vehicle body damage.

In this example, the user may access a mobile app using user device 104. The user may then input an inquiry related to maintenance or repair of vehicles. The inquiry may include, for example, search terms (“door dent panel”), natural language text and/or speech (“This vehicle has a passenger side dent. What parts to I need?”), selection from a menu of options, or other inputs that convey that the user wishes to review and/or perform one or more remedial actions related to repair of a vehicle. For instance, in some embodiments, the user may access the mobile app and initiate capturing real-time image or video data of the vehicle using, for example, a camera of user device 104, and the system (e.g., computing device 102) may use various image processing functionality to identify that there is a subject component (e.g., a “subject vehicle component,” in the context of the present example) within the real-time image/video stream, and, in some further instances, that the subject component is one or more parts of a vehicle (e.g., a front door, a rear door, one or more body panels, etc.). The system (e.g., computing device 102) may process a user inquiry (which may include the above-described real-time image/video stream) and generate AR interface 900 in response thereto.

The generated AR interface 900 may be displayed by user device 104. AR interface 900 may include a background, which may include photographic imagery captured by, for example, the camera of user device 104. This photographic imagery may be continually updated in real time (e.g., by periodically or continuously capturing new images/video with the camera) so that AR interface 900 represents a present view of or within, for example, a vehicle 902, and/or of a subject vehicle component 904, which may include, in this example, one or more vehicle doors and/or side body panels. Alternatively, the background may be a virtual representation of vehicle 902 and/or vehicle component 904, rather than a live image/video.

In the exemplary embodiment, as described above, computing device 102 may be configured to identify a subject component (e.g., a subject vehicle component) depicted in a real-time image/video stream, and/or in one or more images or videos that may have been previously captured and provided to computing device 102 as part of the inquiry. In this example case, computing device 102 may identify the depicted vehicle component 904 as a front passenger door 906, a rear passenger door 908, a first body panel 910, and a second body panel 912 (e.g., using image/video processing functionality, which may include AI and/or ML techniques).

Moreover, computing device 102 may further identify one or more characteristics of the vehicle component (e.g., using image/video processing functionality, which may include AI and/or ML techniques). In the example case, computing device 102 may be configured to identify a make, model, year, etc. of vehicle 902; details (e.g., SKU, model number, etc.) of body panels 910, 912; and/or a status of doors 906, 908 and/or body panels 910, 912 (which may include or be associated with, for example, a type, extent, or location of damage thereto). In so doing, computing device 102 may tailor responses to the inquiry to that vehicle make/model/year, body panel model, ad/or door/panel status.

In some embodiments, computing device 102 may use the identified component characteristics to query one or more databases (e.g., database 112) for resources related to the subject vehicle component (e.g., “vehicle doors” in general) and/or one more identified vehicle characteristics (e.g., the model/year of vehicle 902, the model of body panels 910, 912, the type of damage to body panels 910, 912, etc.). The resources may include, for example, installation guides, catalogues, repair manuals, and the like. Additionally or alternatively, computing device 102 may query one or more dynamic data sources other than a database of computer system 100, such as various Internet sources.

In the illustrated embodiment, AR interface 900 includes an overlay 920 generated by computing device 102 (e.g., in response to the inquiry). In this example, overlay 920 includes a plurality of maintenance labels, including graphical labels 922 as well as a text-based or instructional label 924 (which may also be referred to generally as an instructional overlay or instructional panel). For example, graphical labels 922 identify areas of interest relative to the depicted vehicle component 904. In this instance, areas of damage, which may include a larger or general area of damage as well as a localized area of more severe damage. In the illustrated embodiment, instructional label 924 instructs a user (e.g., a viewer) of one or more remedial actions to be taken relative to the depicted vehicle component 904 (e.g., “REPLACE BODY PANELS,” “CHECK DOOR LATCH FUNCTION”) as determined or identified by computing device 102. In some embodiments, overlay 920 may additionally or alternatively include various details or data elements that computing device 102 has identified (and/or that have been provided to computing device 102 as part of the inquiry), including the subject vehicle component (“VEHICLE DOOR”), a status thereof (“DENTED”), and the like.

Overlay 902 also includes display instructions defining the relative location of labels 922, 924 relative to the background (i.e., the live, real-time image or video stream). For instance, labels 922 may be defined to be displayed relative to the actual areas of damage being depicted. Instructional label 924, by contrast, may be defined to be displayed in a location that does not visually obstruct the areas of interest.

The locations of the various elements of overlay 920 may be continually refreshed (e.g., a location and/or angle of the camera changes with respect to the location of vehicle 902) so that the locations of the various elements of overlay 920 remain corresponding to the actual locations of the applicable elements of vehicle 902.

With reference now to FIG. 10, the depicted AR interface 1000 may be similar to AR or VR interface 800 and/or AR interface 900, in that AR interface 1000 may be generated by, for example, computing device 102 and displayed by user device 104, which may be, for example, an AR/VR headset. In this example, AR interface 1000 may be an AR representation of a maintenance targeting related to vehicles, such as the maintenance and/or repair of vehicle components within an engine bay.

The user may access a mobile app using user device 104. The user may then input an inquiry related to maintenance or repair of vehicles. The inquiry may include, for example, search terms (“vehicle battery” or “oil change”), natural language text and/or speech (“This vehicle needs an oil change. What should I do first?”), selection from a menu of options, or other inputs that convey that the user wishes to review and/or perform one or more remedial actions related to repair or maintenance of a vehicle. For instance, in some embodiments, the user may access the mobile app and initiate capturing real-time image or video data of the vehicle using, for example, a camera of user device 1000, and the system (e.g., computing device 102) may use various image processing functionality to identify that there is a subject vehicle component within the real-time image/video stream, and, in some further instances, that the subject vehicle component is one or more internal components of a vehicle (e.g., an engine, a battery, an oil dipstick, etc.). The system (e.g., computing device 102) may process a user inquiry (which may include the above-described real-time image/video stream) and generate AR interface 1000 in response thereto.

The generated AR interface 1000 may be displayed by user device 104. AR interface 1300 may include a background, which may include photographic imagery captured by, for example, the camera of user device 104. This photographic imagery may be continually updated in real time (e.g., by periodically or continuously capturing new images/video with the camera) so that AR interface 1000 represents a present view of or within, for example, vehicle 902 (also shown in FIG. 9), and/or of a subject vehicle component 1002, which may include, in this example, one or more components within an engine bay of vehicle 902. Alternatively, the background may be a virtual representation of vehicle 902 and/or vehicle component 1002, rather than a live image/video.

In the exemplary embodiment, as described above, computing device 102 may be configured to identify a subject component (e.g., subject vehicle component 1002) depicted in a real-time image/video stream, and/or in one or more images or videos that may have been previously captured and provided to computing device 102 as part of the inquiry. In this example case, computing device 102 may identify a depicted vehicle component 1002 as a battery 1004, an oil dipstick 1006, a power steering fluid reservoir 1008, etc. (e.g., using image/video processing functionality, which may include AI and/or ML techniques).

Moreover, computing device 102 may further identify one or more characteristics of the vehicle component (e.g., using image/video processing functionality, which may include AI and/or ML techniques). In the example case, computing device 102 may be configured to identify a make, model, year, etc. of vehicle 902, and, based thereon, may retrieve, access, or determine the vehicle components present within the engine bay, their relative location, and, in some instance, their brands and/or models. In so doing, computing device 102 may tailor responses to the inquiry to that vehicle make/model/year and those particular vehicle components 1002.

In some embodiments, computing device 102 may use the identified components, and/or characteristics thereof, to query one or more databases (e.g., database 112) for resources related to vehicle 902, one or more subject vehicle components 1002, and/or one more identified vehicle characteristics. The resources may include, for example, training documents, catalogues, repair manuals, and the like. Additionally or alternatively, computing device 102 may query one or more dynamic data sources other than a database of computer system 100, such as various Internet sources.

In the illustrated embodiment, AR interface 1000 includes an overlay 1010 generated by computing device 102 (e.g., in response to the inquiry). In this example, overlay 1020 includes a plurality of maintenance labels, including graphical labels 1012. For example, graphical labels 1012 identify areas of interest relative to the depicted vehicle 1002 and/or vehicle component(s) 1002 – in this instance, areas of interest relative to a maintenance task, such as an oil change. In some embodiments, overlay 1010 may further include text-based or instructional labels, which may be identify the vehicle components 1302 highlighted by graphical labels, or may instruct a user (e.g., a viewer) of one or more remedial actions to be taken relative to the depicted vehicle component(s) 1002, as determined or identified by computing device 102. In some embodiments, overlay 1010 may additionally or alternatively include various details or data elements that computing device 102 has identified (and/or that have been provided to computing device 102 as part of the inquiry), including a subject vehicle component, a status thereof, and the like.

Overlay 1010 may also include display instructions defining the relative location of labels 1012 relative to the background (i.e., the live, real-time image or video stream). For instance, labels 1012 may be defined to be displayed relative to the actual components they are functioning to identify or highlight. The locations of the various elements of overlay 1010 may be continually refreshed (e.g., a location and/or angle of the camera changes with respect to the location of vehicle 902) so that the locations of the various elements of overlay 1010 remain corresponding to the actual locations of the applicable elements of vehicle 902.

### EXEMPLARY COMPUTER-IMPLEMENTED METHOD FOR INSPECTING AND SERVICING A VEHICLE USING AI-BASED TOOLS

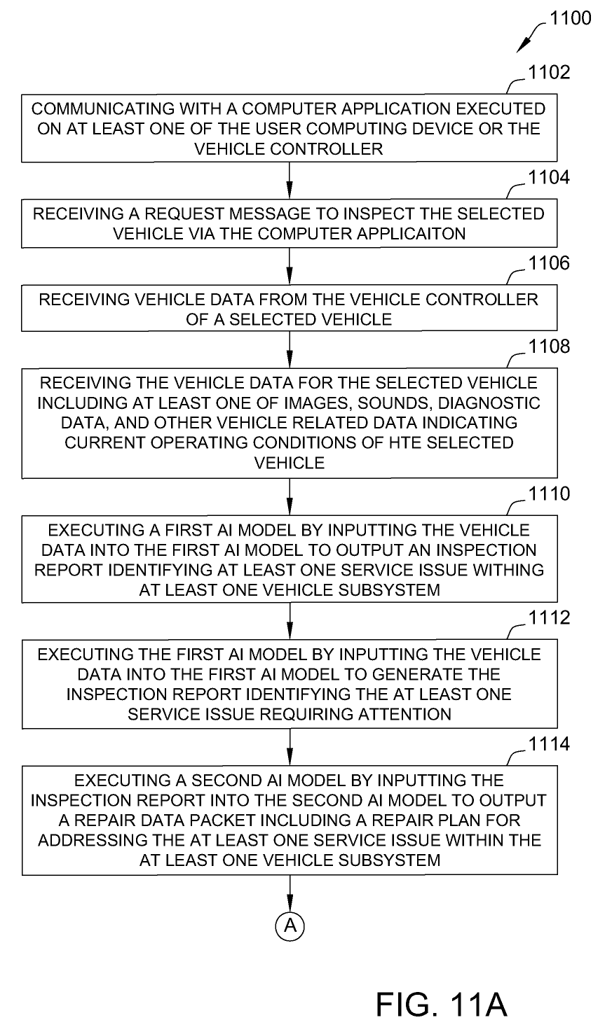

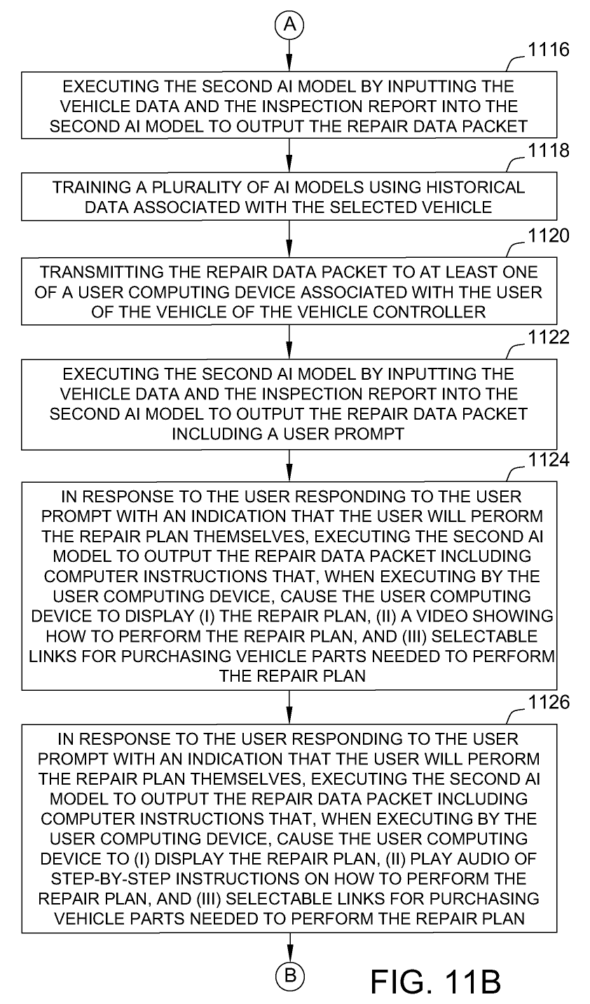

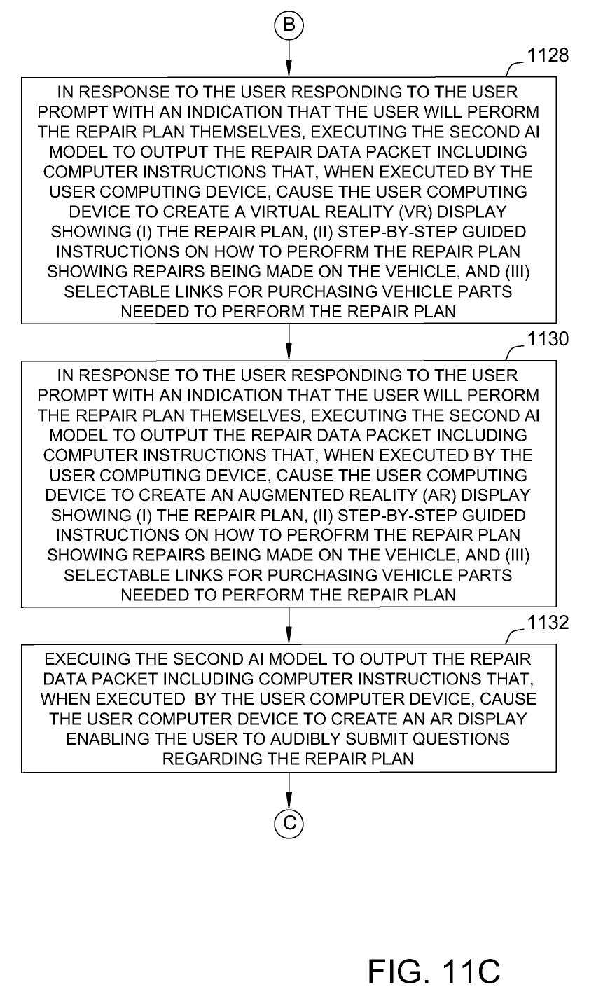

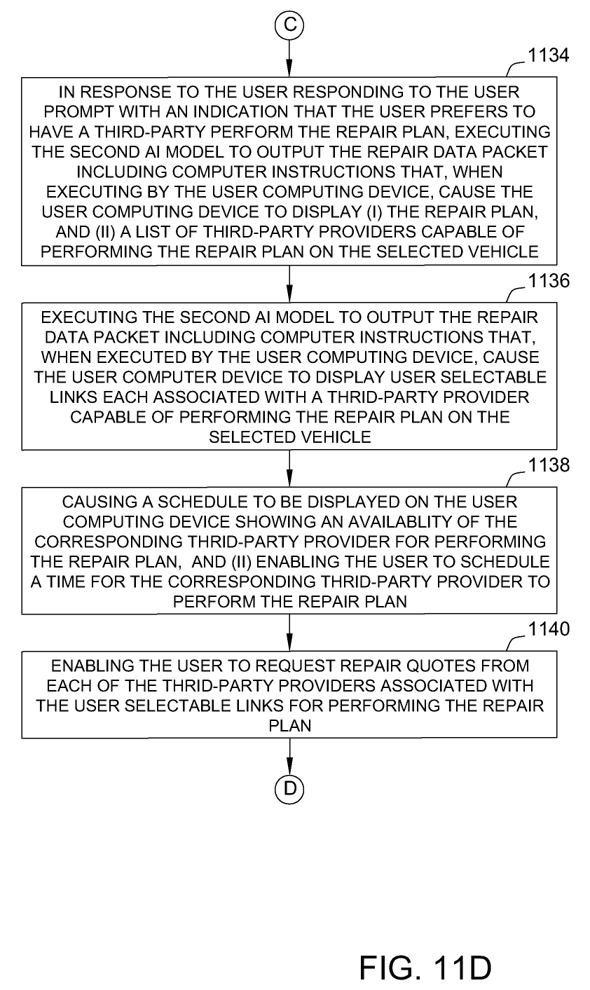

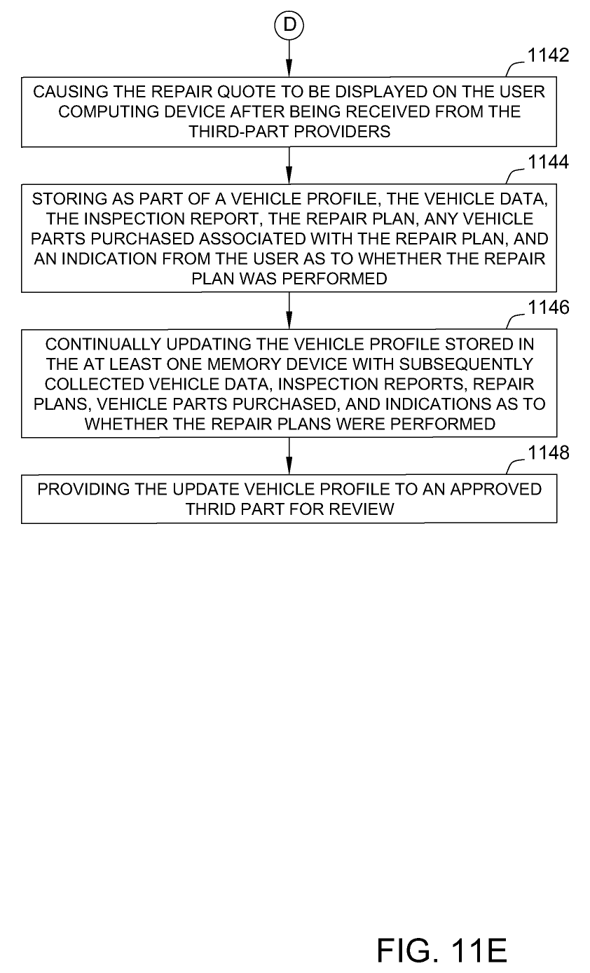

FIGS. 11A-11E depict a flowchart of an exemplary computer-implemented method 1100 for inspecting and servicing a vehicle such as vehicle 106 (shown in FIG. 1) using AI-based tools. Computer-implemented method 1100 may be implemented by system 100 (shown in FIG. 1) a computing device, for example server computing device 102 (shown in FIG. 1). In the exemplary embodiment, server computing device 102 may be in communication with one or more user computing devices 104 and one or more vehicle controllers 108 (both shown in FIG. 1).

Computer-implemented method 1100 may include communicating (block 1102) with a computer application executed on at least one of the user computing device or the vehicle controller. In the exemplary embodiment, the functions depicted in block 1102 may be performed by server computing device 102, for example, by executing processor 505 (shown in FIG. 5).

Computer-implemented method 1100 may further include receiving (block 1104) a request message to inspect the selected vehicle via the computer application. The request message may cause the at least one processor to retrieve the vehicle data from at least one or the vehicle controller or the user computing device. In the exemplary embodiment, the functions depicted in block 1104 may be performed by server computing device 102, for example, by executing processor 505.

Computer-implemented method 1100 may further include receiving (block 1106) vehicle data from the vehicle controller of a selected vehicle. The vehicle data may be collected by one or more vehicle sensors in communication with the vehicle controller, and the vehicle data may relate to at least one of a plurality of vehicle subsystems. In the exemplary embodiment, the functions depicted in block 1106 may be performed by server computing device 102, for example, by executing processor 505.

In certain embodiments, the vehicle data may be collected by one or more vehicle sensors in communication with the vehicle controller. The one or more vehicle sensors may include at least one of audio sensors, video sensors, diagnostic sensors mounted within the vehicle, and/or other sensors for detecting or measuring parameters associated with the vehicle.

In some embodiments, the vehicle data may be additionally received from the user computing device or from a second user computing device. In such embodiments, the vehicle data may include audio data, video data, image data, and/or text data inputted using the user computing device or the second user computing device, and the second user computing device may include smart glasses, a VR headset, an AR headset, or other smart wearable device.

In certain embodiments, the vehicle data associated with the vehicle being inspected may include at least one of audio data, video data, vehicle diagnostic data and/or other sensor data associated with the vehicle for describing a parameter used for inspecting the vehicle.

Computer-implemented method 1100 may further include receiving (block 1108) receiving the vehicle data for the selected vehicle including at least one of images, sounds, diagnostic data, and other vehicle related data indicating current operating conditions of the selected vehicle. In the exemplary embodiment, the functions depicted in block 1108 may be performed by server computing device 102, for example, by executing processor 505.

Computer-implemented method 1100 may further include executing (block 1110) a first AI model by inputting the vehicle data into the first AI model to output an inspection report identifying at least one service issue within at least one vehicle subsystem. In the exemplary embodiment, the functions depicted in block 1110 may be performed by server computing device 102, for example, by executing processor 505.

Computer-implemented method 1100 may further include executing (block 1112) the first AI model by inputting the vehicle data into the first AI model to generate the inspection report identifying the at least one service issue requiring attention. In the exemplary embodiment, the functions depicted in block 1112 may be performed by server computing device 102, for example, by executing processor 505.

Computer-implemented method 1100 may further include executing (block 1114) a second AI model by inputting the inspection report into the second AI model to output a repair data packet including a repair plan for addressing the at least one service issue within the at least one vehicle subsystem. In the exemplary embodiment, the functions depicted in block 1114 may be performed by server computing device 102, for example, by executing processor 505.

Computer-implemented method 1100 may further include executing (block 1116) the second AI model by inputting the vehicle data and the inspection report into the second AI model to output the repair data packet. The repair data packet may include computer instructions that cause the user computing device or the vehicle controller to display (i) the repair plan including a description of the at least one service issue, (ii) a video showing how to perform the repair plan, and (iii) selectable links for purchasing vehicle parts needed to perform the repair plan. In the exemplary embodiment, the functions depicted in block 1116 may be performed by server computing device 102, for example, by executing processor 505.

In some embodiments, the AI-based tools may include a plurality of AI models including the first AI model and the second AI model, wherein the first AI model and/or the second AI model may includes at least one of an LLM, an SLM, an ML model, computer vision tools, and/or a Generative AI model, and wherein the first AI model may be different from the second AI model, and wherein the first AI model may be configured to analyze vehicle data and identify service issues within the vehicle including service issues within one or more subsystems included within the vehicle.

In certain embodiments, the AI-based tools may include a plurality of AI models including the first AI model and the second AI model, wherein the first AI model and/or the second AI model includes at least one of an LLM, an SLM, an ML model, computer vision tools, and/or a Generative AI model, and wherein the first AI model may be different from the second AI model, and wherein the second AI model may be configured to analyze vehicle data and/or the inspection report to generate the repair data packet including the repair plan for servicing the identified at least one service issue within the one or more subsystems included within the vehicle.

In some embodiments, the first AI model and the second AI model may be the same AI model.

Computer-implemented method 1100 may further include training (block 1118) a plurality of AI models using historical data associated with the selected vehicle, which may include vehicle manufacturer’s data, vehicle schematic data, common issues and solutions data for the selected vehicle located via the Internet, expert insight data, local repair locations data; ratings data for local repair shops, vehicle parts ordering data, vehicle and device repair manuals, vehicle software data, insurance claims data, and other data relating to the inspection and repair of vehicles. In the exemplary embodiment, the functions depicted in block 1118 may be performed by server computing device 102, for example, by executing processor 505.

Computer-implemented method 1100 may further include transmitting (block 1120) the repair data packet to at least one of a user computing device associated with the user of the vehicle or the vehicle controller. The repair data packet may include computer instructions that cause the user computing device or the vehicle controller to display the repair plan including a description of the at least one service issue and a recommendation on how to service the at least one service issue. In the exemplary embodiment, the functions depicted in block 1120 may be performed by server computing device 102, for example, by executing processor 505.

Computer-implemented method 1100 may further include executing (block 1122) the second AI model by inputting the vehicle data and the inspection report into the second AI model to output the repair data packet including a user prompt. The repair data packet may include computer instructions that, when executed by the user computing device, cause the user computing device to display the repair plan along with the user prompt requesting whether the user plans to perform the repair plan on their own or would prefer third-party help. In the exemplary embodiment, the functions depicted in block 1122 may be performed by server computing device 102, for example, by executing processor 505.

Computer-implemented method 1100 may further include, in response to the user responding to the user prompt with an indication that the user will perform the repair plan themselves, executing (block 1124) the second AI model to output the repair data packet including computer instructions that, when executed by the user computing device, cause the user computing device to display (i) the repair plan, (ii) a video showing how to perform the repair plan, and (iii) selectable links for purchasing vehicle parts needed to perform the repair plan. In the exemplary embodiment, the functions depicted in block 1124 may be performed by server computing device 102, for example, by executing processor 505.

Computer-implemented method 1100 may further include, in response to the user responding to the user prompt with an indication that the user will perform the repair plan themselves, executing (block 1126) the second AI model to output the repair data packet including computer instructions that, when executed by the user computing device, cause the user computing device to (i) display the repair plan, (ii) play audio of step-by-step instructions on how to perform the repair plan, and (iii) selectable links for purchasing vehicle parts needed to perform the repair plan. In the exemplary embodiment, the functions depicted in block 1116 may be performed by server computing device 102, for example, by executing processor 505.

Computer-implemented method 1100 may further include, in response to the user responding to the user prompt with an indication that the user will perform the repair plan themselves, executing (block 1128) the second AI model to output the repair data packet including computer instructions that, when executed by the user computing device, cause the user computing device to create a virtual reality (VR) display showing (i) the repair plan, (ii) step-by-step guided instructions on how to perform the repair plan showing repairs being made on the vehicle, and (iii) selectable links for purchasing vehicle parts needed to perform the repair plan. In the exemplary embodiment, the functions depicted in block 1128 may be performed by server computing device 102, for example, by executing processor 505.

Computer-implemented method 1100 may further include, in response to the user responding to the user prompt with an indication that the user will perform the repair plan themselves, executing (block 1130) the second AI model to output the repair data packet including computer instructions that, when executed by the user computing device, cause the user computing device to create an augmented reality (AR) display showing (i) the repair plan, (ii) step-by-step guided instructions on how to perform the repair plan showing repairs being made on the vehicle, and (iii) selectable links for purchasing vehicle parts needed to perform the repair plan. In the exemplary embodiment, the functions depicted in block 1130 may be performed by server computing device 102, for example, by executing processor 505.

Computer-implemented method 1100 may further include executing (block 1132) the second AI model to output the repair data packet including computer instructions that, when executed by the user computing device, cause the user computing device to create an AR display enabling the user to audibly submit questions regarding the repair plan. The second AI model may be further configured to output responses to the submitted questions. In the exemplary embodiment, the functions depicted in block 1132 may be performed by server computing device 102, for example, by executing processor 505.

Computer-implemented method 1100 may further include, in response to the user responding to the user prompt with an indication that the user prefers to have a third-party perform the repair plan, executing (block 1134) the second AI model to output the repair data packet including computer instructions that, when executed by the user computing device, cause the user computing device to display (i) the repair plan, and (ii) a list of third-party providers capable of performing the repair plan on the selected vehicle. In the exemplary embodiment, the functions depicted in block 1134 may be performed by server computing device 102, for example, by executing processor 505.

Computer-implemented method 1100 may further include executing (block 1136) the second AI model to output the repair data packet including computer instructions that, when executed by the user computing device, cause the user computing device to display user selectable links each associated with a third-party provider capable of performing the repair plan on the selected vehicle. In the exemplary embodiment, the functions depicted in block 1136 may be performed by server computing device 102, for example, by executing processor 505.

Computer-implemented method 1100 may further include, in response to one of the user selectable links being selected, (i) causing (block 1138) a schedule to be displayed on the user computing device showing an availability of the corresponding third-party provider for performing the repair plan, and (ii) enabling (block 1138) the user to schedule a time for the corresponding third-party provider to perform the repair plan. In the exemplary embodiment, the functions depicted in block 1138 may be performed by server computing device 102, for example, by executing processor 505.

Computer-implemented method 1100 may further include enabling (block 1140) the user to request repair quotes from each of the third-party providers associated with the user selectable links for performing the repair plan. In the exemplary embodiment, the functions depicted in block 1140 may be performed by server computing device 102, for example, by executing processor 505.

Computer-implemented method 1100 may further include causing (block 1142) the repair quotes to be displayed on the user computing device after being received from the third-party providers. In the exemplary embodiment, the functions depicted in block 1142 may be performed by server computing device 102, for example, by executing processor 505.

Computer-implemented method 1100 may further include storing (block 1144), in at least one memory device (e.g., database 112), as part of a vehicle profile, the vehicle data, the inspection report, the repair plan, any vehicle parts purchased associated with the repair plan, and an indication from the user as to whether the repair plan was performed. In the exemplary embodiment, the functions depicted in block 1144 may be performed by server computing device 102, for example, by executing processor 505.

Computer-implemented method 1100 may further include continually updating (block 1146) the vehicle profile stored in the at least one memory device with subsequently collected vehicle data, inspection reports, repair plans, vehicle parts purchased, and indications as to whether the repair plans were performed. In the exemplary embodiment, the functions depicted in block 1146 may be performed by server computing device 102, for example, by executing processor 505.

Computer-implemented method 1100 may further include providing (block 1148) the updated vehicle profile to an approved third party for review. In the exemplary embodiment, the functions depicted in block 1148 may be performed by server computing device 102, for example, by executing processor 505.

### EXEMPLARY COMPUTER-IMPLEMENTED METHOD FOR INSPECTING AND SERVICING A VEHICLE BASED UPON AUDIO AND/OR IMAGE DATA USING AI-BASED TOOLS

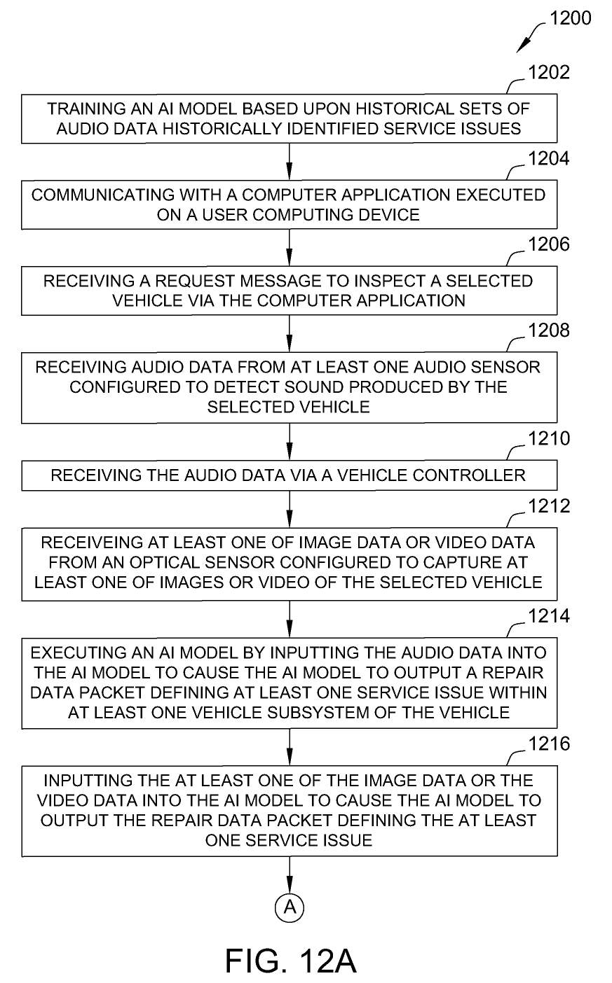

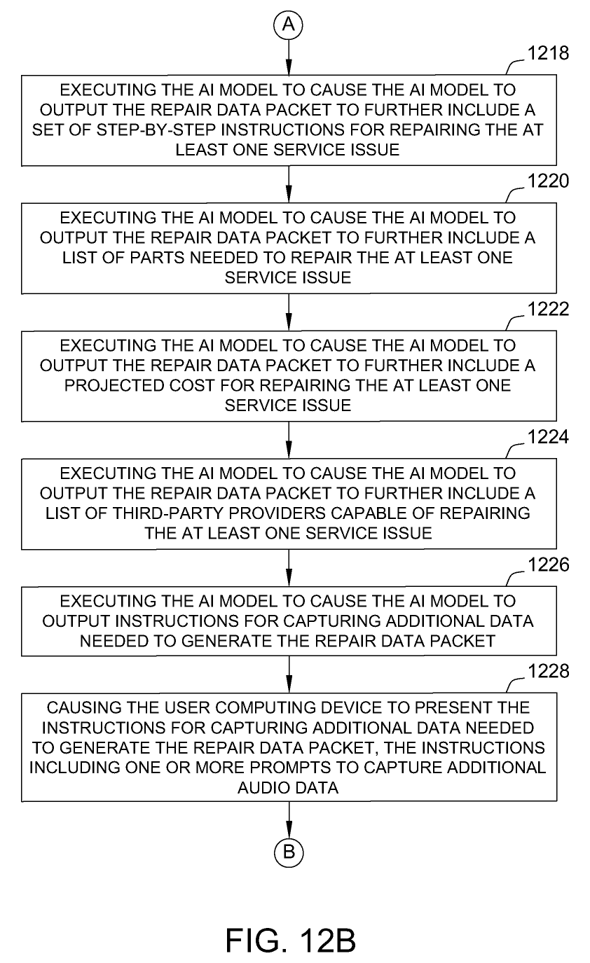

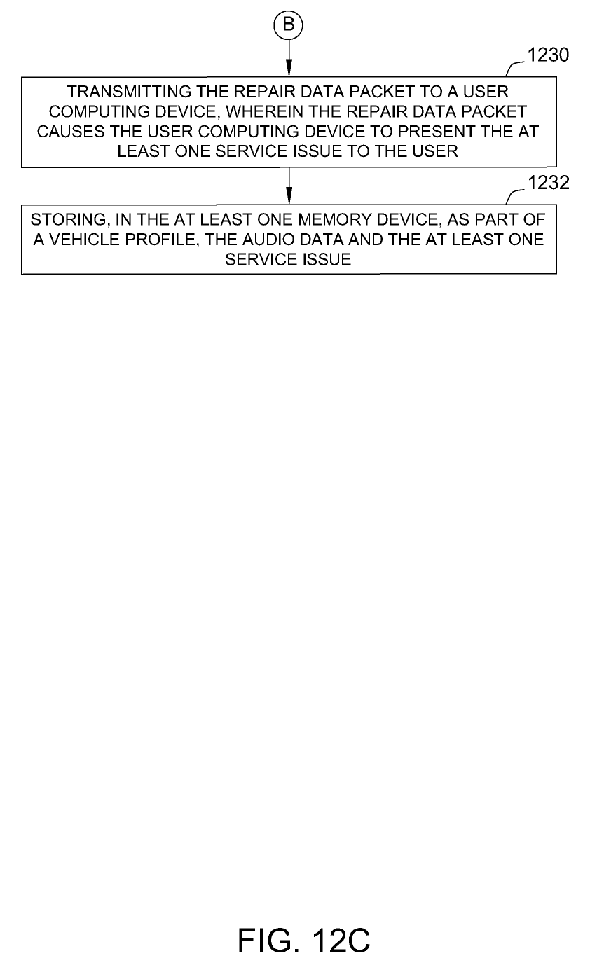

FIGS. 12A-12C depict a flowchart of an exemplary computer-implemented method 1200 for inspecting and servicing a vehicle such as vehicle 106 (shown in FIG. 1) based upon audio and/or image data using AI-based tools. Computer-implemented method 1200 may be implemented by system 100 (shown in FIG. 1) a computing device, for example server computing device 102 (shown in FIG. 1). In the exemplary embodiment, server computing device 102 may be in communication with one or more user computing devices 104 and one or more vehicle controllers 108 (both shown in FIG. 1).

Computer-implemented method 1200 may include training (block 1202) an AI model based upon historical sets of audio data historically identified service issues. In the exemplary embodiment, the functions depicted in block 1202 may be performed by server computing device 102, for example, by executing processor 505.

Computer-implemented method 1200 may further include communicating (block 1204) with a computer application executed on a user computing device. In the exemplary embodiment, the functions depicted in block 1204 may be performed by server computing device 102, for example, by executing processor 505.

Computer-implemented method 1200 may further include receiving (block 1206) a request message to inspect a selected vehicle via the computer application. In the exemplary embodiment, the functions depicted in block 1206 may be performed by server computing device 102, for example, by executing processor 505.

Computer-implemented method 1200 may further include receiving (block 1208) audio data from at least one audio sensor configured to detect sound produced by the selected vehicle. In the exemplary embodiment, the functions depicted in block 1208 may be performed by server computing device 102, for example, by executing processor 505.

Computer-implemented method 1200 may further include receiving (block 1210) the audio data via a vehicle controller. In the exemplary embodiment, the functions depicted in block 1210 may be performed by server computing device 102, for example, by executing processor 505.

Computer-implemented method 1200 may further include receiving (block 1212) at least one of image data or video data from an optical sensor configured to capture at least one of images or video of the selected vehicle. In the exemplary embodiment, the functions depicted in block 1212 may be performed by server computing device 102, for example, by executing processor 505.

Computer-implemented method 1200 may further include executing (block 1214) an AI model by inputting the audio data into the AI model to cause the AI model to output a repair data packet defining at least one service issue within at least one vehicle subsystem of the vehicle. In the exemplary embodiment, the functions depicted in block 1214 may be performed by server computing device 102, for example, by executing processor 505.

Computer-implemented method 1200 may further include inputting (block 1216) the at least one of the image data or the video data into the AI model to cause the AI model to output the repair data packet defining the at least one service issue. In the exemplary embodiment, the functions depicted in block 1216 may be performed by server computing device 102, for example, by executing processor 505.

Computer-implemented method 1200 may further include executing (block 1218) the AI model to cause the AI model to output the repair data packet to further include a set of step-by-step instructions for repairing the at least one service issue. In the exemplary embodiment, the functions depicted in block 1218 may be performed by server computing device 102, for example, by executing processor 505.

Computer-implemented method 1200 may further include executing (block 1220) the AI model to cause the AI model to output the repair data packet to further include a list of parts needed to repair the at least one service issue. In the exemplary embodiment, the functions depicted in block 1220 may be performed by server computing device 102, for example, by executing processor 505.

Computer-implemented method 1200 may further include executing (block 1222) the AI model to cause the AI model to output the repair data packet to further include a projected cost for repairing the at least one service issue. In the exemplary embodiment, the functions depicted in block 1222 may be performed by server computing device 102, for example, by executing processor 505.

Computer-implemented method 1200 may further include executing (block 1224) the AI model to cause the AI model to output the repair data packet to further include a list of third-party providers capable of repairing the at least one service issue. In the exemplary embodiment, the functions depicted in block 1224 may be performed by server computing device 102, for example, by executing processor 505.

Computer-implemented method 1200 may further include executing (block 1226) the AI model to cause the AI model to output instructions for capturing additional data needed to generate the repair data packet. In the exemplary embodiment, the functions depicted in block 1226 may be performed by server computing device 102, for example, by executing processor 505.

Computer-implemented method 1200 may further include causing (block 1228) the user computing device to present the instructions for capturing additional data needed to generate the repair data packet, the instructions including one or more prompts to capture additional audio data. In the exemplary embodiment, the functions depicted in block 1218may be performed by server computing device 102, for example, by executing processor 505.

Computer-implemented method 1200 may further include transmitting (block 1230) the repair data packet to a user computing device, wherein the repair data packet causes the user computing device to present the at least one service issue to the user. In the exemplary embodiment, the functions depicted in block 1230 may be performed by server computing device 102, for example, by executing processor 505.

Computer-implemented method 1200 may further include storing (block 1232), in the at least one memory device, as part of a vehicle profile, the audio data and the at least one service issue. In the exemplary embodiment, the functions depicted in block 1232 may be performed by server computing device 102, for example, by executing processor 505.

### EXEMPLARY COMPUTER-IMPLEMENTED METHOD FOR PROVIDING AN AR OR VR INTERFACE FOR INSPECTING AND SERVICING A VEHICLE USING AI-BASED TOOLS

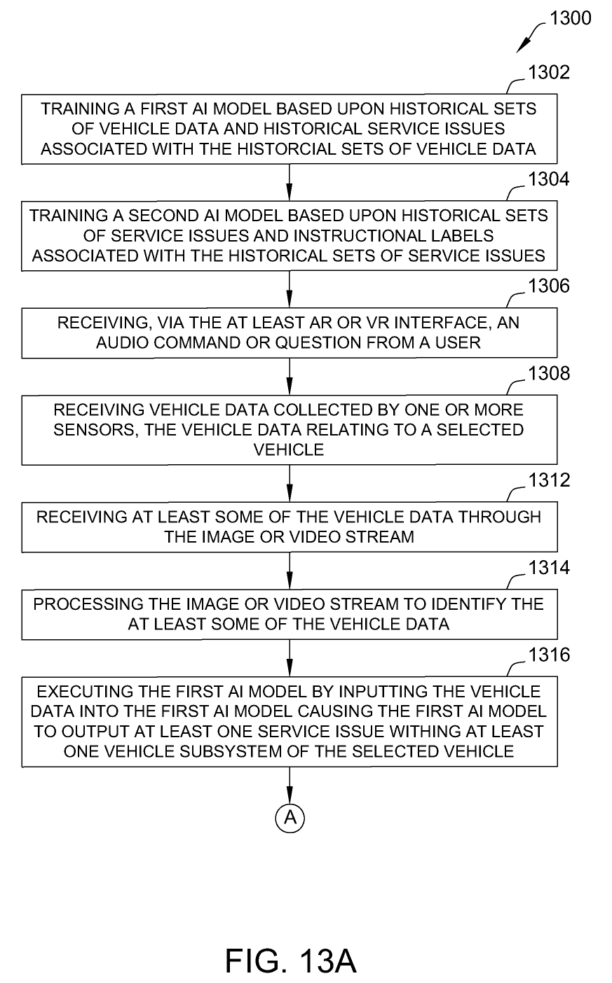

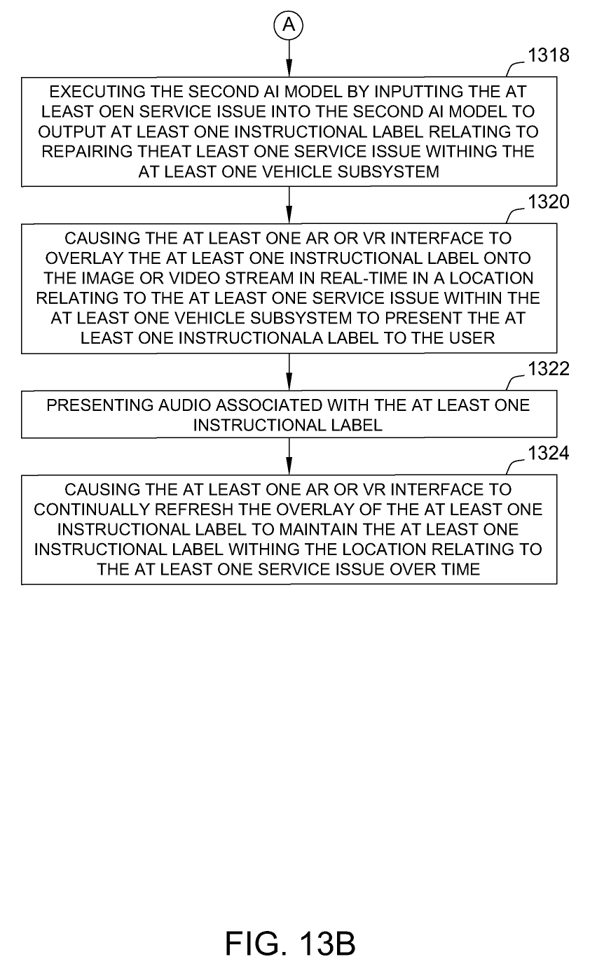

FIGS. 13 A and 13B depict a flowchart of an exemplary computer-implemented method 1300 for providing an AR or VR interface for inspecting and servicing a vehicle such as vehicle 106 (shown in FIG. 1) using AI-based tools. Computer-implemented method 1300 may be implemented by system 100 (shown in FIG. 1) a computing device, for example server computing device 102 (shown in FIG. 1). In the exemplary embodiment, server computing device 102 may be in communication with one or more user computing devices such as user computing device 104 and/or an AR or VR display.

Computer-implemented method 1300 may include training (block 1302) a first AI model based upon historical sets of vehicle data and historical service issues associated with the historical sets of vehicle data. In the exemplary embodiment, the functions depicted in block 1302 may be performed by server computing device 102, for example, by executing processor 505.

Computer-implemented method 1300 may further include training (block 1304) a second AI model based upon historical sets of service issues and instructional labels associated with the historical sets of service issues. In the exemplary embodiment, the functions depicted in block 1304 may be performed by server computing device 102, for example, by executing processor 505.

Computer-implemented method 1300 may further include receiving (block 1306), via the at least one AR or VR interface, an audio command or question from a user. In the exemplary embodiment, the functions depicted in block 1306 may be performed by server computing device 102, for example, by executing processor 505.

Computer-implemented method 1300 may further include receiving (block 1308) vehicle data collected by one or more sensors, the vehicle data relating to a selected vehicle. In the exemplary embodiment, the functions depicted in block 1308 may be performed by server computing device 102, for example, by executing processor 505.

Computer-implemented method 1300 may further include receiving (block 1310) an image or video stream captured at at least one AR or VR interface. In the exemplary embodiment, the functions depicted in block 1310 may be performed by server computing device 102, for example, by executing processor 505.

Computer-implemented method 1300 may further include receiving (block 1312) at least some of the vehicle data through the image or video stream. In the exemplary embodiment, the functions depicted in block 1312 may be performed by server computing device 102, for example, by executing processor 505.

Computer-implemented method 1300 may further include processing (block 1314) the image or video stream to identify the at least some of the vehicle data. In the exemplary embodiment, the functions depicted in block 1314 may be performed by server computing device 102, for example, by executing processor 505.

Computer-implemented method 1300 may further include executing (block 1316) the first AI model by inputting the vehicle data into the first AI model causing the first AI model to output at least one service issue within at least one vehicle subsystem of the selected vehicle. In the exemplary embodiment, the functions depicted in block 1316 may be performed by server computing device 102, for example, by executing processor 505.

Computer-implemented method 1300 may further include executing (block 1318) the second AI model by inputting the at least one service issue into the second AI model to output at least one instructional label relating to repairing the at least one service issue within the at least one vehicle subsystem. In the exemplary embodiment, the functions depicted in block 1318 may be performed by server computing device 102, for example, by executing processor 505.

Computer-implemented method 1300 may further include causing (block 1320) the at least one AR or VR interface to overlay the at least one instructional label onto the image or video stream in real-time in a location relating to the at least one service issue within the at least one vehicle subsystem to present the at least one instructional label to the user. In the exemplary embodiment, the functions depicted in block 1320 may be performed by server computing device 102, for example, by executing processor 505.

Computer-implemented method 1300 may further include presenting (block 1322) audio associated with the at least one instructional label. In the exemplary embodiment, the functions depicted in block 1322 may be performed by server computing device 102, for example, by executing processor 505.

Computer-implemented method 1300 may further include causing (block 1324) the at least one AR or VR interface to continually refresh the overlay of the at least one instructional label to maintain the at least one instructional label within the location relating to the at least one service issue over time. In the exemplary embodiment, the functions depicted in block 1324 may be performed by server computing device 102, for example, by executing processor 505.

### EXEMPLARY EMBODIMENTS

In an exemplary embodiment, a computer system for inspecting and servicing a vehicle associated with a user using AI-based tools is provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer system may include at least one processor and/or associated transceiver in communication with at least one memory device. The at least one processor may be in further communication with a vehicle controller. The at least one processor is programmed to (i) receive vehicle data from the vehicle controller of a selected vehicle, the vehicle data collected by one or more vehicle sensors in communication with the vehicle controller, the vehicle data relating to at least one of a plurality of vehicle subsystems; (ii) execute a first AI model by inputting the vehicle data into the first AI model to output an inspection report identifying at least one service issue within at least one vehicle subsystem; (iii) execute a second AI model by inputting the inspection report into the second AI model to output a repair data packet including a repair plan for addressing the at least one service issue within the at least one vehicle subsystem; and (iv) transmit the repair data packet to at least one of a user computing device associated with the user of the vehicle or the vehicle controller, wherein the repair data packet includes computer instructions that cause the user computing device or the vehicle controller to display the repair plan including a description of the at least one service issue and a recommendation on how to service the at least one service issue. The computer system may include additional, less, or alternate functions, including those discussed elsewhere herein.

In certain embodiments, the vehicle data may be collected by one or more vehicle sensors in communication with the vehicle controller, and the vehicle sensors may be configured to detect parameters associated with the vehicle.

In some embodiments, the AI-based tools may include a plurality of AI models including the first AI model and the second AI model, the first AI model may be different from the second AI model, and the first AI model may be configured to analyze vehicle data and identify the at least one service issue within the at least one vehicle subsystem.

In certain embodiments, the second AI model may be configured to analyze vehicle data and/or the inspection report to generate the repair data packet including the repair plan for servicing the identified at least one service issue within the at least one vehicle subsystem.

In some embodiments, the first AI model and the second AI model may be the same AI model.

In certain embodiments, the AI-based tools may include a plurality of AI models, and the at least one processor may be further programmed to train the plurality of AI models using historical data associated with the selected vehicle.

In some embodiments, vehicle data may be additionally received from at least one of the user computing device or from a second user computing device.

In certain embodiments, the vehicle data received from at least one of the user computing device or from a second user computing device may include at least one of audio data, video data, image data, or text data input using the user computing device or the second user computing device.

In some embodiments, the second user computing device may include at least one of smart glasses, a VR headset, an AR headset, or a smart wearable device.

In certain embodiments, the at least one processor may be further programmed to receive the vehicle data from at least one of the user computing device or the second user computing device including image data showing the selected vehicle, execute the first AI model by inputting the image data to output an inspection report identifying the at least one service issue, and execute the second AI model by inputting the image data and the inspection report into the second AI model to output the repair data packet.

In some embodiments the at least one processor may be further programmed to receive the vehicle data from the vehicle controller including diagnostic data of the selected vehicle, execute the first AI model by inputting the diagnostic data to output an inspection report identifying the at least one service issue, and execute the second AI model by inputting the diagnostic data and the inspection report into the second AI model to output the repair data packet.

In certain embodiments, the computer instructions included in the repair data packet, when executed by the user computing device, may further cause the user computing device to display the repair plan along with a user prompt requesting whether the user plans to perform the repair plan on their own or would prefer third-party help.

In some embodiments, the computer instructions included in the repair data packet, when executed by the user computing device, may further cause the user computing device to display, in response to the user indicating the user plans to perform the repair plan on their own, at least one of (i) at least one of video or audio including instructions on how to perform the repair plan, or (ii) selectable links for purchasing vehicle parts needed to perform the repair plan.

In certain embodiments, the computer instructions included in the repair data packet, when executed by the user computing device, may further cause the user computing device to display, in response to the user indicating the user would prefer third-party help, at least one of (i) a list of third-party providers capable of performing the repair plan on the selected vehicle, (ii) selectable links each associated with a third-party provider capable of performing the repair plan on the selected vehicle, (iii) a showing an availability of one or more of the third-party providers for performing the repair plan, or (iv) repair quotes from one or more of third-party providers.

In some embodiments, the at least one processor may be further programmed to store, in the at least one memory device, as part of a vehicle profile, the vehicle data, the inspection report, the repair plan, any and an indication from the user as to whether the repair plan was performed.

In certain embodiments, the at least one processor may be further programmed to continually update the vehicle profile stored in the at least one memory device with subsequently collected vehicle data, inspection reports, repair plans, and indications as to whether the repair plans were performed.

In another aspect, a computer-implemented method for inspecting and servicing a vehicle associated with a user using AI-based tools is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device. The at least one processor may be in further communication with a vehicle controller. The method may include: (i) receiving vehicle data from the vehicle controller of a selected vehicle, the vehicle data collected by one or more vehicle sensors in communication with the vehicle controller, the vehicle data relating to at least one of a plurality of vehicle subsystems; (ii) executing a first AI model by inputting the vehicle data into the first AI model to output an inspection report identifying at least one service issue within at least one vehicle subsystem; (iii) executing a second AI model by inputting the inspection report into the second AI model to output a repair data packet including a repair plan for addressing the at least one service issue within the at least one vehicle subsystem; and (iv) transmitting the repair data packet to at least one of a user computing device associated with the user of the vehicle or the vehicle controller, wherein the repair data packet includes computer instructions that cause the user computing device or the vehicle controller to display the repair plan including a description of the at least one service issue and a recommendation on how to service the at least one service issue. The computer-implemented method may include additional, less, or alternate actions, including those discussed elsewhere herein.

In certain embodiments, the vehicle data may be collected by one or more vehicle sensors in communication with the vehicle controller, and the vehicle sensors may be configured to detect parameters associated with the vehicle.

In some embodiments, the AI-based tools may include a plurality of AI models including the first AI model and the second AI model, the first AI model may be different from the second AI model, and the first AI model may be configured to analyze vehicle data and identify the at least one service issue within the at least one vehicle subsystem.

In certain embodiments, the second AI model may be configured to analyze vehicle data and/or the inspection report to generate the repair data packet including the repair plan for servicing the identified at least one service issue within the at least one vehicle subsystem.

In some embodiments, the first AI model and the second AI model may be the same AI model.

In certain embodiments, the AI-based tools may include a plurality of AI models, and the computer-implemented method may further include training the plurality of AI models using historical data associated with the selected vehicle.

In some embodiments, vehicle data may be additionally received from at least one of the user computing device or from a second user computing device.

In certain embodiments, the vehicle data received from at least one of the user computing device or from a second user computing device may include at least one of audio data, video data, image data, or text data input using the user computing device or the second user computing device.

In some embodiments, the second user computing device may include at least one of smart glasses, a VR headset, an AR headset, or a smart wearable device.

In certain embodiments, the computer-implemented method may further include receiving the vehicle data from at least one of the user computing device or the second user computing device including image data showing the selected vehicle, execute the first AI model by inputting the image data to output an inspection report identifying the at least one service issue, and execute the second AI model by inputting the image data and the inspection report into the second AI model to output the repair data packet.

In some embodiments the computer-implemented method may further include receiving the vehicle data from the vehicle controller including diagnostic data of the selected vehicle, execute the first AI model by inputting the diagnostic data to output an inspection report identifying the at least one service issue, and execute the second AI model by inputting the diagnostic data and the inspection report into the second AI model to output the repair data packet.

In certain embodiments, the computer instructions included in the repair data packet, when executed by the user computing device, may further cause the user computing device to display the repair plan along with a user prompt requesting whether the user plans to perform the repair plan on their own or would prefer third-party help.

In some embodiments, the computer instructions included in the repair data packet, when executed by the user computing device, may further cause the user computing device to display, in response to the user indicating the user plans to perform the repair plan on their own, at least one of (i) at least one of video or audio including instructions on how to perform the repair plan, or (ii) selectable links for purchasing vehicle parts needed to perform the repair plan.

In certain embodiments, the computer instructions included in the repair data packet, when executed by the user computing device, may further cause the user computing device to display, in response to the user indicating the user would prefer third-party help, at least one of (i) a list of third-party providers capable of performing the repair plan on the selected vehicle, (ii) selectable links each associated with a third-party provider capable of performing the repair plan on the selected vehicle, (iii) a showing an availability of one or more of the third-party providers for performing the repair plan, or (iv) repair quotes from one or more of third-party providers.

In some embodiments, the computer-implemented method may further include storing, in the at least one memory device, as part of a vehicle profile, the vehicle data, the inspection report, the repair plan, any and an indication from the user as to whether the repair plan was performed.

In certain embodiments, the computer-implemented method may further include continually updating the vehicle profile stored in the at least one memory device with subsequently collected vehicle data, inspection reports, repair plans, and indications as to whether the repair plans were performed.

In another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device. The computer-executable instructions may direct or cause the at least one processor to: (i) receive vehicle data from the vehicle controller of a selected vehicle, the vehicle data collected by one or more vehicle sensors in communication with the vehicle controller, the vehicle data relating to at least one of a plurality of vehicle subsystems; (ii) execute a first AI model by inputting the vehicle data into the first AI model to output an inspection report identifying at least one service issue within at least one vehicle subsystem; (iii) execute a second AI model by inputting the inspection report into the second AI model to output a repair data packet including a repair plan for addressing the at least one service issue within the at least one vehicle subsystem; and (iv) transmit the repair data packet to at least one of a user computing device associated with the user of the vehicle or the vehicle controller, wherein the repair data packet includes computer instructions that cause the user computing device or the vehicle controller to display the repair plan including a description of the at least one service issue and a recommendation on how to service the at least one service issue. The non-transitory computer-readable media having computer-executable instructions embodied thereon may have additional, less, or alternate functionality, including that discussed elsewhere herein.

In certain embodiments, the vehicle data may be collected by one or more vehicle sensors in communication with the vehicle controller, and the vehicle sensors may be configured to detect parameters associated with the vehicle.

In some embodiments, the AI-based tools may include a plurality of AI models including the first AI model and the second AI model, the first AI model may be different from the second AI model, and the first AI model may be configured to analyze vehicle data and identify the at least one service issue within the at least one vehicle subsystem.

In certain embodiments, the second AI model may be configured to analyze vehicle data and/or the inspection report to generate the repair data packet including the repair plan for servicing the identified at least one service issue within the at least one vehicle subsystem.

In some embodiments, the first AI model and the second AI model may be the same AI model.

In certain embodiments, the AI-based tools may include a plurality of AI models, and the computer-executable instructions may further cause the at least one processor to train the plurality of AI models using historical data associated with the selected vehicle.

In some embodiments, vehicle data may be additionally received from at least one of the user computing device or from a second user computing device.

In certain embodiments, the vehicle data received from at least one of the user computing device or from a second user computing device may include at least one of audio data, video data, image data, or text data input using the user computing device or the second user computing device.

In some embodiments, the second user computing device may include at least one of smart glasses, a VR headset, an AR headset, or a smart wearable device.

In certain embodiments, the computer-executable instructions may further cause the at least one processor to receive the vehicle data from at least one of the user computing device or the second user computing device including image data showing the selected vehicle, execute the first AI model by inputting the image data to output an inspection report identifying the at least one service issue, and execute the second AI model by inputting the image data and the inspection report into the second AI model to output the repair data packet.

In some embodiments the computer-executable instructions may further cause the at least one processor to receive the vehicle data from the vehicle controller including diagnostic data of the selected vehicle, execute the first AI model by inputting the diagnostic data to output an inspection report identifying the at least one service issue, and execute the second AI model by inputting the diagnostic data and the inspection report into the second AI model to output the repair data packet.

In certain embodiments, the computer instructions included in the repair data packet, when executed by the user computing device, may further cause the user computing device to display the repair plan along with a user prompt requesting whether the user plans to perform the repair plan on their own or would prefer third-party help.

In some embodiments, the computer instructions included in the repair data packet, when executed by the user computing device, may further cause the user computing device to display, in response to the user indicating the user plans to perform the repair plan on their own, at least one of (i) at least one of video or audio including instructions on how to perform the repair plan, or (ii) selectable links for purchasing vehicle parts needed to perform the repair plan.

In certain embodiments, the computer instructions included in the repair data packet, when executed by the user computing device, may further cause the user computing device to display, in response to the user indicating the user would prefer third-party help, at least one of (i) a list of third-party providers capable of performing the repair plan on the selected vehicle, (ii) selectable links each associated with a third-party provider capable of performing the repair plan on the selected vehicle, (iii) a showing an availability of one or more of the third-party providers for performing the repair plan, or (iv) repair quotes from one or more of third-party providers.

In some embodiments, the computer-executable instructions may further cause the at least one processor to store, in the at least one memory device, as part of a vehicle profile, the vehicle data, the inspection report, the repair plan, any and an indication from the user as to whether the repair plan was performed.

In certain embodiments, the computer-executable instructions may further cause the at least one processor to continually update the vehicle profile stored in the at least one memory device with subsequently collected vehicle data, inspection reports, repair plans, and indications as to whether the repair plans were performed.

In another exemplary embodiment, a computer system for inspecting and servicing a vehicle associated with a user using AI-based tools is provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer system may include at least one processor and/or associated transceiver in communication with at least one memory device. The at least one processor is programmed to (i) receive audio data from at least one audio sensor configured to detect sound produced by a selected vehicle; (ii) execute an AI model by inputting the audio data into the AI model to cause the AI model to output a repair data packet defining at least one service issue within at least one vehicle subsystem of the vehicle, the AI model trained based upon historical sets of audio data and historically identified service issues associated with one or more of the historical sets of audio data; and/or (iii) transmit the repair data packet to a user computing device, wherein the repair data packet causes the user computing device to present the at least one service issue to the user. The computer system may include additional, less, or alternate functions, including those discussed elsewhere herein.

In certain embodiments, the at least one processor may be further programmed to train the AI model based upon the historical sets of audio data and historically identified service issues.

In some embodiments, the at least one processor may be further programmed to execute the AI model to cause the AI model to output the repair data packet to further include a set of step-by-step instructions for repairing the at least one service issue, wherein the repair data packet further causes the user computing device to present the set of step-by-step instructions for repairing the at least one service issue.

In certain embodiments the at least one processor may be further programmed to execute the AI model to cause the AI model to output the repair data packet to further include a list of parts needed to repair the at least one service issue, wherein the repair data packet further causes the user computing device to present the list of parts.

In some embodiments, the at least one processor may be further programmed to execute the AI model to cause the AI model to output the repair data packet to further include a projected cost for repairing the at least one service issue, wherein the repair data packet further causes the user computing device to present the projected cost.

In certain embodiments, the at least one processor may be further programmed to execute the AI model to cause the AI model to output the repair data packet to further include a list of third-party providers capable of repairing the at least one service issue, wherein the repair data packet further causes the user computing device to present the list.

In some embodiments, the at least one processor may be further programmed to execute the AI model to cause the AI model to output instructions for capturing additional data needed to generate the repair data packet and cause the user computing device to present the instructions for capturing additional data needed to generate the repair data packet, the instructions including one or more prompts to capture additional audio data.

In certain embodiments, the additional data may include at least one of audio data or video data.

In some embodiments, the at least one processor may be further programmed to receive at least one of image data or video data from an optical sensor configured to capture at least one of images or video of the selected vehicle and further input the at least one of the image data or the video data into the AI model to cause the AI model to output the repair data packet defining the at least one service issue, wherein the AI model is further trained based upon historical sets of image data or video data and historically identified service issues associated with one or more of the historical sets of image data or video data.

In certain embodiments, the at least one audio sensor may be mounted within the selected vehicle, the at least one processor may be in further communication with a vehicle controller of the selected vehicle, the vehicle controller in communication with the at least one sensor, and the at least one processor may be further programmed to receive the audio data via the vehicle controller.

In some embodiments, the at least one audio sensor may be incorporated into the user computing device.

In certain embodiments, the at least one audio sensor may be incorporated into one of more of smart glasses, a VR headset, an AR headset, or a smart wearable device.

In some embodiments, the one of more of the smart glasses, the VR headset, the AR headset, or the smart wearable device may be in communication with or is incorporated into the user computing device.

In certain embodiments, the at least one service issue may be presented to the user via the one of more of the smart glasses, the VR headset, the AR headset, or the smart wearable device is in communication with or is incorporated into the user computing device.

In some embodiments, the at least one processor may be further programmed to communicate with a computer application executed on the user computing device and receive a request message to inspect the selected vehicle via the computer application, wherein the request message causes the at least one processor to retrieve the audio data.

In certain embodiments, the at least one processor may be further programmed to store, in the at least one memory device, as part of a vehicle profile, the audio data and the at least one service issue.

In another exemplary embodiment, a computer-implemented method for inspecting and servicing a vehicle associated with a user using AI-based tools is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device. The method may include: (i) receiving, by the at least one processor audio data from at least one audio sensor configured to detect sound produced by a selected vehicle; (ii) executing, by the at least one processor, an AI model by inputting the audio data into the AI model to cause the AI model to output a repair data packet defining at least one service issue within at least one vehicle subsystem of the vehicle, the AI model trained based upon historical sets of audio data and historically identified service issues associated with one or more of the historical sets of audio data; and/or (iii) transmitting, by the at least one processor, the repair data packet to a user computing device, wherein the repair data packet causes the user computing device to present the at least one service issue to the user. The computer-implemented method may include additional, less, or alternate actions, including those discussed elsewhere herein.

In certain embodiments, the computer-implemented method may further include training the AI model based upon the historical sets of audio data and historically identified service issues.

In some embodiments, the computer-implemented method may further include executing the AI model to cause the AI model to output the repair data packet to further include a set of step-by-step instructions for repairing the at least one service issue, wherein the repair data packet further causes the user computing device to present the set of step-by-step instructions for repairing the at least one service issue.

In certain embodiments the computer-implemented method may further include executing the AI model to cause the AI model to output the repair data packet to further include a list of parts needed to repair the at least one service issue, wherein the repair data packet further causes the user computing device to present the list of parts.

In some embodiments, the computer-implemented method may further include executing the AI model to cause the AI model to output the repair data packet to further include a projected cost for repairing the at least one service issue, wherein the repair data packet further causes the user computing device to present the projected cost.

In certain embodiments, the computer-implemented method may further include executing the AI model to cause the AI model to output the repair data packet to further include a list of third-party providers capable of repairing the at least one service issue, wherein the repair data packet further causes the user computing device to present the list.

In some embodiments, computer-implemented method may further include executing the AI model to cause the AI model to output instructions for capturing additional data needed to generate the repair data packet and causing the user computing device to present the instructions for capturing additional data needed to generate the repair data packet, the instructions including one or more prompts to capture additional audio data.

In certain embodiments, the additional data may include at least one of audio data or video data.

In some embodiments, the computer-implemented method may further include receiving at least one of image data or video data from an optical sensor configured to capture at least one of images or video of the selected vehicle and further input the at least one of the image data or the video data into the AI model to cause the AI model to output the repair data packet defining the at least one service issue, wherein the AI model is further trained based upon historical sets of image data or video data and historically identified service issues associated with one or more of the historical sets of image data or video data.

In certain embodiments, the at least one audio sensor may be mounted within the selected vehicle, the at least one processor may be in further communication with a vehicle controller of the selected vehicle, the vehicle controller in communication with the at least one sensor, and the computer-implemented method may further include receiving the audio data via the vehicle controller.

In some embodiments, the at least one audio sensor may be incorporated into the user computing device.

In certain embodiments, the at least one audio sensor may be incorporated into one of more of smart glasses, a VR headset, an AR headset, or a smart wearable device.

In some embodiments, the one of more of the smart glasses, the VR headset, the AR headset, or the smart wearable device may be in communication with or is incorporated into the user computing device.

In certain embodiments, the at least one service issue may be presented to the user via the one of more of the smart glasses, the VR headset, the AR headset, or the smart wearable device is in communication with or is incorporated into the user computing device.

In some embodiments, the computer-implemented method may further include communicating with a computer application executed on the user computing device and receiving a request message to inspect the selected vehicle via the computer application, wherein the request message causes the at least one processor to retrieve the audio data.

In certain embodiments, the computer-implemented method may further include storing, in the at least one memory device, as part of a vehicle profile, the audio data and the at least one service issue.

In another exemplary embodiment, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device. The computer-executable instructions may direct or cause the at least one processor to: (i) receive audio data from at least one audio sensor configured to detect sound produced by a selected vehicle; (ii) execute an AI model by inputting the audio data into the AI model to cause the AI model to output a repair data packet defining at least one service issue within at least one vehicle subsystem of the vehicle, the AI model trained based upon historical sets of audio data and historically identified service issues associated with one or more of the historical sets of audio data; and/or (iii) transmit the repair data packet to a user computing device, wherein the repair data packet causes the user computing device to present the at least one service issue to the user. The non-transitory computer-readable media having computer-executable instructions embodied thereon may have additional, less, or alternate functionality, including that discussed elsewhere herein.

In certain embodiments, the computer-executable instructions may further cause the at least one processor to train the AI model based upon the historical sets of audio data and historically identified service issues.

In some embodiments, the computer-executable instructions may further cause the at least one processor to execute the AI model to cause the AI model to output the repair data packet to further include a set of step-by-step instructions for repairing the at least one service issue, wherein the repair data packet further causes the user computing device to present the set of step-by-step instructions for repairing the at least one service issue.

In certain embodiments the computer-executable instructions may further cause the at least one processor to execute the AI model to cause the AI model to output the repair data packet to further include a list of parts needed to repair the at least one service issue, wherein the repair data packet further causes the user computing device to present the list of parts.

In some embodiments, the computer-executable instructions may further cause the at least one processor to execute the AI model to cause the AI model to output the repair data packet to further include a projected cost for repairing the at least one service issue, wherein the repair data packet further causes the user computing device to present the projected cost.

In certain embodiments, the computer-executable instructions may further cause the at least one processor to execute the AI model to cause the AI model to output the repair data packet to further include a list of third-party providers capable of repairing the at least one service issue, wherein the repair data packet further causes the user computing device to present the list.

In some embodiments, computer-executable instructions may further cause the at least one processor to execute the AI model to cause the AI model to output instructions for capturing additional data needed to generate the repair data packet and cause the user computing device to present the instructions for capturing additional data needed to generate the repair data packet, the instructions including one or more prompts to capture additional audio data.

In certain embodiments, the additional data may include at least one of audio data or video data.

In some embodiments, the computer-executable instructions may further cause the at least one processor to receive at least one of image data or video data from an optical sensor configured to capture at least one of images or video of the selected vehicle and further input the at least one of the image data or the video data into the AI model to cause the AI model to output the repair data packet defining the at least one service issue, wherein the AI model is further trained based upon historical sets of image data or video data and historically identified service issues associated with one or more of the historical sets of image data or video data.

In certain embodiments, the at least one audio sensor may be mounted within the selected vehicle, the at least one processor may be in further communication with a vehicle controller of the selected vehicle, the vehicle controller in communication with the at least one sensor, and the computer-executable instructions may further cause the at least one processor to receive the audio data via the vehicle controller.

In some embodiments, the at least one audio sensor may be incorporated into the user computing device.

In certain embodiments, the at least one audio sensor may be incorporated into one of more of smart glasses, a VR headset, an AR headset, or a smart wearable device.

In some embodiments, the one of more of the smart glasses, the VR headset, the AR headset, or the smart wearable device may be in communication with or is incorporated into the user computing device.

In certain embodiments, the at least one service issue may be presented to the user via the one of more of the smart glasses, the VR headset, the AR headset, or the smart wearable device is in communication with or is incorporated into the user computing device.

In some embodiments, the computer-executable instructions may further cause the at least one processor to communicate with a computer application executed on the user computing device and receive a request message to inspect the selected vehicle via the computer application, wherein the request message causes the at least one processor to retrieve the audio data.

In certain embodiments, the computer-executable instructions may further cause the at least one processor to store, in the at least one memory device, as part of a vehicle profile, the audio data and the at least one service issue.

In another aspect, a computer system for inspecting and servicing a vehicle associated with a user using AI-based tools is provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer system may include at least one processor and/or associated transceiver in communication with at least one memory device. The at least one processor may be in further communication with at least one AR or VR interface. The at least one processor may be programmed to: (i) receive vehicle data collected by one or more sensors, the vehicle data relating to a selected vehicle; (ii) receive an image or video stream captured at the at least one AR or VR interface; (iii) execute a first AI model by inputting the vehicle data into the first AI model causing the first AI model to output at least one service issue within at least one vehicle subsystem of the selected vehicle; (iv) execute a second AI model by inputting the at least one service issue into the second AI model to output at least one instructional label relating to repairing the at least one service issue within the at least one vehicle subsystem; and/or (v) cause the at least one AR or VR interface to overlay the at least one instructional label onto the image or video stream in real-time in a location relating to the at least one service issue within the at least one vehicle subsystem to present the at least one instructional label to the user. The computer system may include additional, less, or alternate functions, including those discussed elsewhere herein.

In certain embodiments, at least one of the one or more sensors may be incorporated in to the at least one AR or VR interface, and the at least one processor may be further programmed to receive at least some of the vehicle data through the image or video stream.

In some embodiments, the first AI model may be configured to process the image or video stream to identify the at least some of the vehicle data.

In certain embodiments, the at least one instructional label may include an object overlay indicating a location of the at least one vehicle subsystem or a component of interest of the vehicle.

In some embodiments, the at least one instructional label may include instructional text.

In certain embodiments, the at least one processor may be further programmed to cause the at least one AR or VR interface to present audio associated with the at least one instructional label.

In some embodiments, the at least one processor may be further programmed to receive, via the at least one AR or VR interface, an audio command or question from the user, wherein the at least one instructional label is generated based at least in part upon the audio command or question.

In certain embodiments, the audio command or question may include natural language, and at least one of the first AI model or the second AI model may be configured to process the natural language to generate the instructional label.

In some embodiments, the at least one processor may be further programmed to cause the at least one AR or VR interface to continually refresh the overlay of the at least one instructional label to maintain the at least one instructional label within the location relating to the at least one service issue over time.

In certain embodiments, the at least one processor may be further programmed to train the first AI model based upon historical sets of vehicle data and historical service issues associated with the historical sets of vehicle data.

In some embodiments, the at least one processor may be further programmed to train the second AI model based upon historical sets of service issues and instructional labels associated with the historical sets of service issues.

In certain embodiments, the first AI model may be separate from the second AI model.

In some embodiments, the first AI model and the second AI model may be a combined AI model.

In certain embodiments, the at least one AR or VR interface may include one or more of smart glasses, an AR headset, a VR headset, or a smart wearable device.

In another aspect, a computer-implemented method for inspecting and servicing a vehicle associated with a user using AI-based tools is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ML models, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device. The at least one processor may be in further communication with at least one AR or VR interface. The method may include: (i) receiving, by the at least one processor, vehicle data collected by one or more sensors, the vehicle data relating to a selected vehicle; (ii) receiving, by the at least one processor, an image or video stream captured at the at least one AR or VR interface; (iii) executing, by the at least one processor, a first AI model by inputting the vehicle data into the first AI model causing the first AI model to output at least one service issue within at least one vehicle subsystem of the selected vehicle; (iv) executing, by the at least one processor, a second AI model by inputting the at least one service issue into the second AI model to output at least one instructional label relating to repairing the at least one service issue within the at least one vehicle subsystem; and/or (v) causing, by the at least one processor, the at least one AR or VR interface to overlay the at least one instructional label onto the image or video stream in real-time in a location relating to the at least one service issue within the at least one vehicle subsystem to present the at least one instructional label to the user. The computer-implemented method may include additional, less, or alternate actions, including those discussed elsewhere herein.

In certain embodiments, at least one of the one or more sensors may be incorporated in to the at least one AR or VR interface, and the computer-implemented method may further include receiving at least some of the vehicle data through the image or video stream.

In some embodiments, the first AI model may be configured to process the image or video stream to identify the at least some of the vehicle data.

In certain embodiments, the at least one instructional label may include an object overlay indicating a location of the at least one vehicle subsystem or a component of interest of the vehicle.

In some embodiments, the at least one instructional label may include instructional text.

In certain embodiments, the computer-implemented method may further include causing the at least one AR or VR interface to present audio associated with the at least one instructional label.

In some embodiments, the computer-implemented method may further include receiving, via the at least one AR or VR interface, an audio command or question from the user, wherein the at least one instructional label is generated based at least in part upon the audio command or question.

In certain embodiments, the audio command or question may include natural language, and at least one of the first AI model or the second AI model may be configured to process the natural language to generate the instructional label.

In some embodiments, computer-implemented method may further include causing the at least one AR or VR interface to continually refresh the overlay of the at least one instructional label to maintain the at least one instructional label within the location relating to the at least one service issue over time.

In certain embodiments, the computer-implemented method may further include training the first AI model based upon historical sets of vehicle data and historical service issues associated with the historical sets of vehicle data.

In some embodiments, the computer-implemented method may further include training the second AI model based upon historical sets of service issues and instructional labels associated with the historical sets of service issues.

In certain embodiments, the first AI model may be separate from the second AI model.

In some embodiments, the first AI model and the second AI model may be a combined AI model.

In certain embodiments, the at least one AR or VR interface may include one or more of smart glasses, an AR headset, a VR headset, or a smart wearable device.

In another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with at least one AR or VR interface. The computer-executable instructions may direct or cause the at least one processor to: (i) receive vehicle data collected by one or more sensors, the vehicle data relating to a selected vehicle; (ii) receive an image or video stream captured at the at least one AR or VR interface; (iii) execute a first AI model by inputting the vehicle data into the first AI model causing the first AI model to output at least one service issue within at least one vehicle subsystem of the selected vehicle; (iv) execute a second AI model by inputting the at least one service issue into the second AI model to output at least one instructional label relating to repairing the at least one service issue within the at least one vehicle subsystem; and/or (v) cause the at least one AR or VR interface to overlay the at least one instructional label onto the image or video stream in real-time in a location relating to the at least one service issue within the at least one vehicle subsystem to present the at least one instructional label to the user. The non-transitory computer-readable media having computer-executable instructions embodied thereon may have additional, less, or alternate functionality, including that discussed elsewhere herein.

In certain embodiments, at least one of the one or more sensors may be incorporated in to the at least one AR or VR interface, and the computer-executable instructions may further cause the at least one processor to receive at least some of the vehicle data through the image or video stream.

In some embodiments, the first AI model may be configured to process the image or video stream to identify the at least some of the vehicle data.

In certain embodiments, the at least one instructional label may include an object overlay indicating a location of the at least one vehicle subsystem or a component of interest of the vehicle.

In some embodiments, the at least one instructional label may include instructional text.

In certain embodiments, the computer-executable instructions may further cause the at least one processor to cause the at least one AR or VR interface to present audio associated with the at least one instructional label.

In some embodiments, the computer-executable instructions may further cause the at least one processor to receive, via the at least one AR or VR interface, an audio command or question from the user, wherein the at least one instructional label is generated based at least in part upon the audio command or question.

In certain embodiments, the audio command or question may include natural language, and at least one of the first AI model or the second AI model may be configured to process the natural language to generate the instructional label.

In some embodiments, the computer-executable instructions may further cause the at least one processor to cause the at least one AR or VR interface to continually refresh the overlay of the at least one instructional label to maintain the at least one instructional label within the location relating to the at least one service issue over time.

In certain embodiments, the computer-executable instructions may further cause the at least one processor to train the first AI model based upon historical sets of vehicle data and historical service issues associated with the historical sets of vehicle data.

In some embodiments, computer-executable instructions may further cause the at least one processor to train the second AI model based upon historical sets of service issues and instructional labels associated with the historical sets of service issues.

In certain embodiments, the first AI model may be separate from the second AI model.

In some embodiments, the first AI model and the second AI model may be a combined AI model.

In certain embodiments, the at least one AR or VR interface may include one or more of smart glasses, an AR headset, a VR headset, or a smart wearable device.

### MACHINE LEARNING & OTHER MATTERS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised ML, and the ML program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the ML programs may be trained by inputting sample data sets or certain data into the programs, such as image, mobile device, vehicle telematics, and/or intelligent home telematics data. The ML programs may utilize deep learning algorithms that may be primarily focused on pattern recognition and may be trained after processing multiple examples. The ML programs may include Bayesian program learning (BPL), voice recognition and synthesis, image or object recognition, optical character recognition, and/or natural language processing – either individually or in combination. The ML programs may also include natural language processing, semantic analysis, automatic reasoning, and/or ML.

In supervised ML, a processing element may be provided with example inputs and their associated outputs and may seek to discover a general rule that maps inputs to outputs, so that when subsequent novel inputs may be provided the processing element may, based upon the discovered rule, accurately predict the correct output. In unsupervised ML, the processing element may be required to find its own structure in unlabeled example inputs. In one embodiment, ML techniques may be used to extract the relevant personal belonging and/or home feature information for customers from mobile device sensors, vehicle-mounted sensors, home-mounted sensors, and/or other sensor data, vehicle or home telematics data, image data, and/or other data.

In one embodiment, a processing element may be trained by providing it with a large sample of conventional analog and/or digital, still and/or moving (i.e., video) image data, telematics data, and/or other data of vehicle characteristics or features. Such information may include, for example, make or manufacturer and model information.

Based upon these analyses, the processing element may learn how to identify characteristics and patterns that may then be applied to analyzing sensor data, vehicle telematics data, image data, mobile device data, and/or other data to identify service issues within vehicles and determine appropriate responses.

In some embodiments, voice bots or chatbots, such as those discussed herein, may be configured to utilize AI and/or ML techniques. For instance, the chatbot may be an LLM such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples may be example only and may be thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples may be not intended to limit in any way the definition and/or meaning of the term database. Examples of RDBMS’s include, but may be not limited to, Oracle® Database, MySQL, IBM® DB2, Microsoft® SQL Server, Sybase®, and PostgreSQL. However, any database may be used that may enable the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.).

As used herein, the terms “software” and “firmware” may be interchangeable and include any computer program stored in memory for execution by a processor, including RAM memory, ROM memory, EPROM memory, EEPROM memory, and non-volatile RAM (NVRAM) memory. The above memory types may be example only and may be thus not limiting as to the types of memory usable for storage of a computer program.

In another embodiment, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes may be not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or action or operation recited in the singular and preceded by the word “a” or “an” should be understood as not excluding plural elements or action or operations, unless such exclusion is explicitly recited. Furthermore, references to “exemplary embodiment” or “one embodiment” of the present disclosure may be not intended to be interpreted as excluding the existence of additional embodiments that also incorporate the recited features.

The patent claims at the end of this document may be not intended to be construed under 35 U.S.C. § 112(f) unless traditional means-plus-function language is expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples may be intended to be within the scope of the claims if they have structural elements that do not differ from the literal language of the claims, or if they include equivalent structural elements with insubstantial differences from the literal language of the claims.

We claim:

1. A computer system for inspecting and servicing a vehicle associated with a user using artificial intelligence (AI) based tools, the computer system comprising at least one processor and at least one memory device in communication therewith, the at least one processor in further communication with a vehicle controller, the at least one processor programmed to:
receive vehicle data from the vehicle controller of a selected vehicle, the vehicle data collected by one or more vehicle sensors in communication with the vehicle controller, the vehicle data relating to at least one of a plurality of vehicle subsystems;
execute a first AI model by inputting the vehicle data into the first AI model to output an inspection report identifying at least one service issue within at least one vehicle subsystem;
execute a second AI model by inputting the inspection report into the second AI model to output a repair data packet including a repair plan for addressing the at least one service issue within the at least one vehicle subsystem; and
transmit the repair data packet to at least one of a user computing device associated with the user of the vehicle or the vehicle controller,
wherein the repair data packet includes computer instructions that cause the user computing device or the vehicle controller to display the repair plan including a description of the at least one service issue and a recommendation on how to service the at least one service issue.

2. The computer system of claim 1, wherein the vehicle data is collected by one or more vehicle sensors in communication with the vehicle controller, the vehicle sensors configured to detect parameters associated with the vehicle.

3. The computer system of claim 1, wherein the AI-based tools include a plurality of AI models including the first AI model and the second AI model, wherein the first AI model is different from the second AI model, and wherein the first AI model is configured to analyze vehicle data and identify the at least one service issue within the at least one vehicle subsystem.

4. The computer system of claim 3, wherein the second AI model is configured to analyze vehicle data and/or the inspection report to generate the repair data packet including the repair plan for servicing the identified at least one service issue within the at least one vehicle subsystem.

5. The computer system of claim 1, wherein the first AI model and the second AI model are the same AI model.

6. The computer system of claim 1, wherein the AI-based tools include a plurality of AI models, and wherein the at least one processor is further programmed to train the plurality of AI models using historical data associated with the selected vehicle.

7. The computer system of claim 1, wherein vehicle data is additionally received from at least one of the user computing device or from a second user computing device.

8. The computer system of claim 7, wherein the vehicle data received from at least one of the user computing device or from a second user computing device includes at least one of audio data, video data, image data, or text data input using the user computing device or the second user computing device.

9. The computer system of claim 7, wherein the second user computing device includes at least one of smart glasses, a virtual reality (VR) headset, an augmented reality (AR) headset, or a smart wearable device.

10. The computer system of claim 7, wherein the at least one processor is further programmed to:
receive the vehicle data from at least one of the user computing device or the second user computing device including image data showing the selected vehicle;
execute the first AI model by inputting the image data to output an inspection report identifying the at least one service issue; and
execute the second AI model by inputting the image data and the inspection report into the second AI model to output the repair data packet.

11. The computer system of claim 1, wherein the at least one processor is further programmed to:
receive the vehicle data from the vehicle controller including diagnostic data of the selected vehicle;
execute the first AI model by inputting the diagnostic data to output an inspection report identifying the at least one service issue; and
execute the second AI model by inputting the diagnostic data and the inspection report into the second AI model to output the repair data packet.

12. The computer system of claim 1, wherein the computer instructions included in the repair data packet, when executed by the user computing device, further cause the user computing device to display the repair plan along with a user prompt requesting whether the user plans to perform the repair plan on their own or would prefer third-party help.

13. The computer system of claim 12, wherein the computer instructions included in the repair data packet, when executed by the user computing device, further cause the user computing device to display, in response to the user indicating the user plans to perform the repair plan on their own, at least one of (i) at least one of video or audio including instructions on how to perform the repair plan, or (ii) selectable links for purchasing vehicle parts needed to perform the repair plan.

14. The computer system of claim 12, wherein the computer instructions included in the repair data packet, when executed by the user computing device, further cause the user computing device to display, in response to the user indicating the user would prefer third-party help, at least one of (i) a list of third-party providers capable of performing the repair plan on the selected vehicle, (ii) selectable links each associated with a third-party provider capable of performing the repair plan on the selected vehicle, (iii) a showing an availability of one or more of the third-party providers for performing the repair plan, or (iv) repair quotes from one or more of third-party providers.

15. The computer system of claim 1, wherein the at least one processor is further programmed to:
store, in the at least one memory device, as part of a vehicle profile, the vehicle data, the inspection report, the repair plan, any and an indication from the user as to whether the repair plan was performed.

16. The computer system of claim 15, wherein the at least one processor is further programmed to:
continually update the vehicle profile stored in the at least one memory device with subsequently collected vehicle data, inspection reports, repair plans, and indications as to whether the repair plans were performed.

17. A computer-implemented method for inspecting and servicing a vehicle associated with a user using artificial intelligence (AI) based tools, the computer-implemented method performed by at least one processor in communication with at least one memory device, the at least one processor in further communication with a vehicle controller, the computer-implemented method comprising:
receiving, by the at least one processor, vehicle data from the vehicle controller of a selected vehicle, the vehicle data collected by one or more vehicle sensors in communication with the vehicle controller, the vehicle data relating to at least one of a plurality of vehicle subsystems;
executing, by the at least one processor, a first AI model by inputting the vehicle data into the first AI model to output an inspection report identifying at least one service issue within at least one vehicle subsystem;
executing, by the at least one processor, a second AI model by inputting the inspection report into the second AI model to output a repair data packet including a repair plan for addressing the at least one service issue within the at least one vehicle subsystem; and
transmitting, by the at least one processor, the repair data packet to at least one of a user computing device associated with the user of the vehicle or the vehicle controller,
wherein the repair data packet includes computer instructions that cause the user computing device or the vehicle controller to display the repair plan including a description of the at least one service issue and a recommendation on how to service the at least one service issue.

18. The computer system of claim 1, wherein the vehicle data is collected by one or more vehicle sensors in communication with the vehicle controller, the vehicle sensors configured to detect parameters associated with the vehicle.

19. The computer system of claim 1, wherein the AI-based tools include a plurality of AI models including the first AI model and the second AI model, wherein the first AI model is different from the second AI model, and wherein the first AI model is configured to analyze vehicle data and identify the at least one service issue within the at least one vehicle subsystem.

20. At least one non-transitory computer-readable media having computer-executable instructions embodied thereon for inspecting and servicing a vehicle associated with a user using artificial intelligence (AI) based tools, wherein when executed by at least one processor in communication with at least one memory device, the at least one processor in further communication with a vehicle controller, the computer-executable instructions cause the at least one processor to:
receive vehicle data from the vehicle controller of a selected vehicle, the vehicle data collected by one or more vehicle sensors in communication with the vehicle controller, the vehicle data relating to at least one of a plurality of vehicle subsystems;
execute a first AI model by inputting the vehicle data into the first AI model to output an inspection report identifying at least one service issue within at least one vehicle subsystem;
execute a second AI model by inputting the inspection report into the second AI model to output a repair data packet including a repair plan for addressing the at least one service issue within the at least one vehicle subsystem; and
transmit the repair data packet to at least one of a user computing device associated with the user of the vehicle or the vehicle controller,
wherein the repair data packet includes computer instructions that cause the user computing device or the vehicle controller to display the repair plan including a description of the at least one service issue and a recommendation on how to service the at least one service issue.
